(19) United States
(12) Patent Application Publication
(10) Pub. No.: US 2014/0234488 A1
(43) Pub. Date: Aug. 21, 2014

(54) BEVERAGE SYSTEM, INCLUDING BUBBLE BEVERAGE, INSTANT BEVERAGE, BEVERAGE WITH DISSOLVED GAS, AND BEVERAGE WITH INGREDIENT

(71) Applicant: Alice Chang, South Pasadena, CA (US)

(72) Inventor: Alice Chang, South Pasadena, CA (US)

(21) Appl. No.: 14/090,436

(22) Filed: Nov. 26, 2013

Related U.S. Application Data
(60) Provisional application No. 61/765,157, filed on Feb. 15, 2013.

(51) Int. Cl. A23L 2/56; C12C 12/00; C12G 3/06; A23L 2/54

(52) U.S. Cl. CPC A23L 2/56; A23L 2/54; C12C 12/00; C12G 3/06
USPC 426/62; 426/597; 426/594; 426/580; 426/583; 426/590; 426/598; 426/66; 426/599; 426/592; 426/589; 426/67; 426/548; 426/72; 426/73; 426/74; 426/106; 426/61; 426/130

(57) ABSTRACT

A beverage system is created having beverage, with at least one liquid. The beverage is created in a variety, including tea drink, coffee drink, milk drink, yogurt drink, malted drink, roasted cereal grain beverage, roasted nut and seed beverage, roasted bean beverage, distilled water, mineral water, sports drink, fruit juice, vegetable juice, fruit drink, vegetable drink, fruit skin drink, vegetable skin drink, plant drink, soft drink, alcoholic drink, and soup drink. The beverage is also created with or without addition of ingredient, including flavoring ingredient, nutritional ingredient, health ingredient, and other ingredient. The beverage can be served as hot drink, cold drink, cold drink with ice, and warm drink. The beverage can be caffeinated, or non caffeinated; and diet or non diet. The liquid includes water, oil, and alcohol. The beverage system is created in various form, including bubble beverage, instant beverage, and beverage with dissolved gas.

### CROSS-REFERENCE TO RELATED APPLICATION

The present application is related to and claims priority from prior provisional application No. 61765157, filed Feb. 15, 2013 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of comestibles, and more specifically relates to a novel beverage system, including bubble beverage, instant beverage, beverage with dissolved gas, and beverage with ingredient.

2. Description of the Related Art

Beverage is a drink comprising liquid, which is specifically prepared for human consumption. Beverage is liquid in the form of water, oil, and alcohol, and with or without flavoring and ingredient. The beverage can be divided into various groups such as plain water, alcohol, non-alcoholic drink, soft drink, fruit juice, vegetable juice, tea coffee, milk, and hot drink. Beverages in the market today are very limited in the form and variety.

Various attempts have been made to solve the above-mentioned problems such as those found in U.S. Pat. Nos. 2,118,184; 4,105,802; 4,946,701; 5,681,569; 6,024,996; 6,723,369; and 2004/0018275. This prior art is representative of comestibles relating to food and beverage compositions. None of the above inventions and patents, taken either singly or in combination, is seen to describe the invention as claimed.

Ideally, beverage system, including bubble beverage, instant beverage, beverage with dissolved gas, and beverage with ingredient should provide nutrition and convenience to consumers and, yet would be manufactured at a modest expense. Thus, a need exists for a novel beverage system in various form, variety, and with various ingredient.

### BRIEF SUMMARY OF THE INVENTION

In view of the foregoing disadvantages inherent in the known beverages related comestibles art, the present invention provides a novel beverage system. The general purpose of the present invention, which will be described subsequently in greater detail is to provide a beverage system, including bubble beverage, instant beverage, beverage with dissolved gas, and beverage with ingredient. The invention is to provide people who shop for beverage the option of getting beverage in various form, variety, and with various ingredient.

The beverage system comprises beverage, with at least one liquid. The beverage is created in a variety, including tea drink, coffee drink, milk drink, yogurt drink, malted drink, roasted cereal grain beverage, roasted nut and seed beverage, roasted bean beverage, distilled water, mineral water, sports drink, fruit juice, vegetable juice, fruit drink, vegetable drink, fruit skin drink, vegetable skin drink, plant drink, soft drink, alcoholic drink, and soup drink. The beverage in a variety is created with or without the addition of ingredient, including at least one flavoring ingredient, at least one nutritional ingredient, at least one health ingredient, and at least one other ingredient. The beverage is served in a manner selected from the group consisting of hot drink, cold drink, drink with ice, and warm drink. The beverage is selected from the group consisting of caffeinated, and non caffeinated. And the beverage is selected from the group consisting of diet, and non diet. At least one liquid is in form selected from the group consisting of water, oil, and alcohol.

The present invention holds significant improvements and serves as a novel beverage system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### DETAILED DESCRIPTION

As discussed above, embodiments of the present invention relate to a comestible and more particularly to a novel beverage system, including bubble beverage, instant beverage, beverage with dissolved gas, and beverage with ingredient.

The purpose of the present invention is to create beverage in various form, variety, and with various ingredient.

As mentioned earlier, the beverage system comprises beverage, with at least one liquid. The beverage is created in a variety, including tea drink, coffee drink, milk drink, yogurt drink, malted drink, roasted cereal grain beverage, roasted nut and seed beverage, roasted bean beverage, distilled water, mineral water, sports drink, fruit juice, vegetable juice, fruit drink, vegetable drink, fruit skin drink, vegetable skin drink, plant drink, soft drink, alcoholic drink, and soup drink. The beverage in a variety is created with or without the addition of ingredient, including at least one flavoring ingredient, at least one nutritional ingredient, at least one health ingredient, and at least one other ingredient. The beverage is served in a manner selected from the group consisting of hot drink, cold drink, drink with ice, and warm drink. The beverage is selected from the group consisting of caffeinated, and non caffeinated. And the beverage is selected from the group consisting of diet, and non diet. At least one liquid is in form selected from the group consisting of water, oil, and alcohol.

By making bubble beverage, the consumer can consume starch and/or gelatin in the beverage as small spherical balls or bubbles. By making instant beverage, the consumer can have the convenience to make beverage from a form selected from the group consisting of solid medium in particles, and condensed liquid medium. By making beverage with dissolved gas, including carbon dioxide, ozone, oxygen, and nitrogen, the consumers can enjoy beverages as effervescent iced drinks.

The beverage is created in form selected from the group consisting of bubble beverage, instant beverage, and beverage with dissolved gas.

Bubble beverage is created for consumer to consume small spherical balls mixed into the beverage selected from the group consisting of tapioca balls, sago pearls, starch balls, gelatin balls, and balls with both gelatin and starch. The spherical balls have a diameter of about 1 to 10 millimeters. The bubble beverage can be consumed with a thick drinking straw.

For the bubble beverage, small spherical balls have ingredient selected from the group consisting of gelatin and starch, including gelatin from fish and animal, beaten egg, egg white, pectin, vegetable gum, vegetable starch, corn starch, potato starch, sago, and tapioca. The small spherical balls with gelatin from fish and animal as ingredient can be mixed into cold drink because gelatin congeals below 15 degrees Celsius(59 degrees Fahrenheit). The small spherical balls with starch, egg, and egg white as ingredient can be mixed into cold drink, warm drink, and hot drink.

Instant beverage is created for consumer to have the convenience to make beverage from a form selected from the group consisting of solid medium in particles, and condensed liquid medium.

For the instant beverage, solid medium in particles can be dissolved in hot water for consumption. The solid medium in particles can be created by method selected from the group consisting of drying the beverage into soluble powder, freeze drying the beverage into granules, and spray drying the beverage into granules. The condensed liquid medium can be mixed with water for consumption. The condensed liquid medium can be created by applying heat to vaporize the water.

Beverage with dissolved gas is created for consumer to consume the beverage with dissolved gas selected from the group consisting of carbon dioxide, ozone, oxygen, and nitrogen. The beverage with dissolved gas is in form selected from the group consisting of carbonated, ozonated, oxygenated, and nitrogenated.

For the beverage with dissolved gas, dissolved gas is added to the beverage by method selected from the group consisting of application of pressure, and adding water with said dissolved gas. The dissolved gas is released from the beverage when pressure is reduced as effervescence.

For the beverage system, the beverage can be created by mixing more than one of the beverage selected from the group consisting of at least one tea drink, at least one coffee drink, at least one milk drink, at least one yogurt drink, at least one malted drink, at least one roasted cereal grain beverage, at least one roasted nut and seed beverage, at least one roasted bean beverage, distilled water, at least one mineral water, at least one sports drink, at least one fruit juice, at least one vegetable juice, at least one fruit drink, at least one vegetable drink, at least one fruit skin drink, at least one vegetable skin drink, at least one plant drink, at least one soft drink, at least one alcoholic drink, and at least one soup drink.

Tea drink is created by method selected from the group consisting of peeling skin of ingredient, cutting ingredient into small pieces, grinding ingredient into small particles, drying ingredient by heat, drying ingredient by sun, dry roasting ingredient, placing ingredient in tea bag, placing ingredient in container, mixing boiling water with ingredient, steeping ingredient in boiling water, and removing any residue. The ingredient is selected from the group consisting of leaf, flower, flower bud, pollen, stem, stem shoot, root, bulb, cereal grain, nut, seed, bean, herb, plant, mushroom, fruit, fruit skin, vegetable, and vegetable skin. The tea drink is selected from the group consisting of white tea, yellow tea, green tea, black tea, oolong tea, earl grey, darjeeling, flower tea, root tea, herbal tea, mushroom tea, fruit tea, fruit skin tea, vegetable tea, vegetable skin tea, flavored tea, and tea with addition of ingredient.

Coffee drink is created by brewing one and more of roasted coffee bean. The coffee bean is roasted between 165 to 275 degrees Celsius(329 to 527 degrees Fahrenheit). The coffee bean is roasted for a period of time ranging from about ½ to 30 minutes. The coffee drink can have flavoring selected from the group consisting of natural flavor, artificial flavor, fruit flavor, flower flavor, flower bud flavor, pollen flavor, leaf flavor, stem flavor, stem shoot flavor, bulb flavor, plant flavor, plant oil flavor, root flavor, herb flavor, tea flavor, nut flavor, seed flavor, bean flavor, cereal grain flavor, fruit skin flavor, vegetable skin flavor, vegetable flavor, and vegetable oil flavor. The coffee drink is selected from the group consisting of black coffee, latte, cappuccino, espresso, mocha, frappe, cafe au lait, flavored coffee, and coffee with addition of ingredient.

Milk drink is created by method selected from the group consisting of extracting milk from mammal, pasteurizing milk by heating milk to about 80 degrees Celsius(176 degrees Fahrenheit),boiling plant ingredient and removing residue, grinding and boiling plant ingredient and removing residue, grinding and blending plant ingredient and removing residue, and mixing both mammal milk and plant milk. The mammal is selected from the group consisting of cattle, buffalo, bison, sheep, goat, elk, yak, ewe, mare, water buffalo, horse, reindeer, and camel. The plant ingredient is selected from group consisting of cereal grain, nut, seed, and bean. The cereal grain is selected from the group consisting of rice, barley, oat, barley, rye, corn, wheat, buckwheat, millet, sorghum, spelt, quinoa, chicory, molasses, beet root, fonio, palmer's grass, teff, triticale, cattail, chia, flax, grain amaranth, canihua, pitseed goosefoot, and wattleseed. The nut and seed are selected from the group consisting of almond, cashew, chestnut, coconut, hazelnut, macadamia, peanut, pecan, pine nut, pistachio, walnut, acorn, brazil nut, gingko nut, beechnut, candlenut, kurrajong, mongongo, palm nut, karuka, red bopple nut, hickory, jacknut, pepea nut, yellow walnut, cycad, munya nut, monkey puzzle nut, paradise nut, colocynth, filbert, mamoncillo, maya nut, ogbono nut, water caltrop, juniper, podocarp, cempedak, coffee, egusi, fox nut, jackfruit, malabar gourd, nutmeg, breadnut, betel nut, cola nut, pili nut, olive, drumstick, okra, pumpkin seed, sesame seed, sunflower seed, lotus seed, and hemp seed. The bean is selected from the group consisting of green bean, red bean, azuki bean, black bean, back eyed bean, white bean, yellow bean, common bean, broad bean, pinto bean, soybean, lima bean, kidney bean, pea bean, potato bean, dolichos bean, moth bean, mung bean, ricebean, runner bean, tepary bean, urad bean, velvet bean, winged bean, yardlong bean, chickpea, pigeon pea, snap pea, snow pea, lentil, lupin, tarwi, carob, guar, horse gram, cocoa bean, coffee bean, bambara groundnut, cowpea, hyacinth bean, lablab, moringa oleifera, sterculia, yam bean, alfalfa, clover, mesquite, carob, tamarind, and wisteria. The milk drink can have flavoring selected from the group consisting of natural flavor, artificial flavor, fruit flavor, flower flavor, flower bud flavor, pollen flavor, leaf flavor, stem flavor, stem shoot flavor, bulb flavor, plant flavor, plant oil flavor, root flavor, herb flavor, tea flavor, nut flavor, seed flavor, bean flavor, cereal grain flavor, fruit skin flavor, vegetable skin flavor, vegetable flavor, and vegetable oil flavor. The milk drink is selected from the group consisting of mammal milk, plant milk, whole milk, low fat milk, non fat milk, lactaid milk, chocolate milk, buttermilk, malted milk, flavored milk, and milk with addition of ingredient.

Yogurt drink is created by method selected from the group consisting of heating milk to about 80 degrees Celsius (176 degrees Fahrenheit) for a pasteurization process to kill any undesirable bacteria and to denature milk proteins so that they set together rather than form curds, cooling milk to about 45 degrees Celsius(112 degrees Fahrenheit), adding bacterial culture for bacterial fermentation of milk, and allowing 4 to 7 hours for fermentation. The bacterial fermentation of milk is selected from the group consisting of mammal milk, and plant milk. The mammal milk is extracted from mammal selected from the group consisting of cattle, buffalo, bison, sheep, goat, elk, yak, ewe, mare, water buffalo, horse, reindeer, and camel. The plant milk is created from plant ingredient selected from the group consisting of cereal grain, nut, seed, and bean. The cereal grain is selected from the group consisting of rice, barley, oat, barley, rye, corn, wheat, buckwheat, millet, sorghum, spelt, quinoa, chicory, molasses, beet root, fonio, palmer's grass, teff, triticale, cattail, chia, flax, grain amaranth, canihua, pitseed goosefoot, and wattleseed. The nut and seed are selected from the group consisting of almond, cashew, chestnut, coconut, hazelnut, macadamia, peanut, pecan, pine nut, pistachio, walnut, acorn, brazil nut, gingko nut, beechnut, candlenut, kurrajong, mongongo, palm nut, karuka, red bopple nut, hickory, jacknut, pepea nut, yellow walnut, cycad, munya nut, monkey puzzle nut, paradise nut, colocynth, filbert, mamoncillo, maya nut, ogbono nut, water caltrop, juniper, podocarp, cempedak, coffee, egusi, fox nut, jackfruit, malabar gourd, nutmeg, breadnut, betel nut, cola nut, pili nut, olive, drumstick, okra, pumpkin seed, sesame seed, sunflower seed, lotus seed, and hemp seed. The bean is selected from the group consisting of green bean, red bean, azuki bean, black bean, back eyed bean, white bean, yellow bean, common bean, broad bean, pinto bean, soybean, lima bean, kidney bean, pea bean, potato bean, dolichos bean, moth bean, mung bean, ricebean, runner bean, tepary bean, urad bean, velvet bean, winged bean, yardlong bean, chickpea, pigeon pea, snap pea, snow pea, lentil, lupin, tarwi, carob, guar, horse gram, cocoa bean, coffee bean, bambara groundnut, cowpea, hyacinth bean, lablab, moringa oleifera, sterculia, yam bean, alfalfa, clover, mesquite, carob, tamarind, and wisteria. The plant milk is created by method selected from the group consisting of boiling plant ingredient and removing residue, grinding and boiling plant ingredient and removing residue, grinding and blending plant ingredient and removing residue. The yogurt drink can have flavoring selected from the group consisting of natural flavor, artificial flavor, fruit flavor, flower flavor, flower bud flavor, pollen flavor, leaf flavor, stem flavor, stem shoot flavor, bulb flavor, plant flavor, plant oil flavor, root flavor, herb flavor, tea flavor, nut flavor, seed flavor, bean flavor, cereal grain flavor, fruit skin flavor, vegetable skin flavor, vegetable flavor, and vegetable oil flavor. Yogurt drink is selected from the group consisting of plain yogurt drink, flavored yogurt drink, and yogurt drink with addition of ingredient.

Malted drink is created by method selected from the group consisting of germinating cereal grain, soaking in water, drying with hot air, turning into malt enzyme, using malt for brewing, using malted extract for adding into drink, and removing any residue. The cereal grain is selected from the group consisting of rice, barley, oat, barley, rye, corn, wheat, buckwheat, millet, sorghum, spelt, quinoa, chicory, molasses, beet root, fonio, palmer's grass, teff, triticale, cattail, chia, flax, grain amaranth, canihua, pitseed goosefoot, and wattleseed. The malted drink is selected from the group consisting of beer, non alcoholic beer, ale, lager, and beverage made with malted extract, including malted milk, malted mammal milk, malted plant milk, malted milkshake, malted yogurt, malted coffee, malted tea, malted roasted cereal grain beverage, malted roasted nut and seed beverage, malted roasted bean beverage, malted sports drink, malted fruit juice, malted vegetable juice, malted fruit drink, malted vegetable drink, malted fruit skin drink, malted vegetable skin drink, malted plant drink, malted soft drink, malted alcoholic drink, malted soup drink, and malted drink with addition of ingredient.

Roasted cereal grain beverage is created by brewing one and more of roasted cereal grain. The cereal grain is selected from the group consisting of rice, barley, oat, barley, rye, corn, wheat, buckwheat, millet, sorghum, spelt, quinoa, chicory, molasses, beet root, fonio, palmer's grass, teff, triticale, cattail, chia, flax, grain amaranth, canihua, pitseed goosefoot, and wattleseed. The cereal grain is roasted between 165 to 275 degrees Celsius(329 to 527 degrees Fahrenheit). The cereal grain is roasted for a period of time ranging from about ½ to 30 minutes. The roasted cereal grain beverage is selected from the group consisting of plain, flavored, and with addition of ingredient.

Roasted nut and seed beverage is created by brewing one and more of roasted nut. The nut and seed are selected from the group consisting of almond, cashew, chestnut, coconut, hazelnut, macadamia, peanut, pecan, pine nut, pistachio, walnut, acorn, brazil nut, gingko nut, beechnut, candlenut, kurrajong, mongongo, palm nut, karuka, red bopple nut, hickory, jacknut, pepea nut, yellow walnut, cycad, munya nut, monkey puzzle nut, paradise nut, colocynth, filbert, mamoncillo, maya nut, ogbono nut, water caltrop, juniper, podocarp, cempedak, coffee, egusi, fox nut, jackfruit, malabar gourd, nutmeg, breadnut, betel nut, cola nut, pili nut, olive, drumstick, okra, pumpkin seed, sesame seed, sunflower seed, lotus seed, and hemp seed. The nut and seed are roasted between 165 to 275 degrees Celsius(329 to 527 degrees Fahrenheit). The nut and seed are roasted for a period of time ranging from about ½ to 30 minutes. The roasted nut and seed beverage is selected from the group consisting of plain, flavored, and with addition of ingredient.

Roasted bean beverage is created by brewing one and more of roasted bean. The bean is selected from the group consisting of green bean, red bean, azuki bean, black bean, back eyed bean, white bean, yellow bean, common bean, broad bean, pinto bean, soybean, lima bean, kidney bean, pea bean, potato bean, dolichos bean, moth bean, mung bean, ricebean, runner bean, tepary bean, urad bean, velvet bean, winged bean, yardlong bean, chickpea, pigeon pea, snap pea, snow pea, lentil, lupin, tarwi, carob, guar, horse gram, cocoa bean, coffee bean, bambara groundnut, cowpea, hyacinth bean, lablab, moringa oleifera, sterculia, yam bean, alfalfa, clover, mesquite, carob, tamarind, and wisteria. The bean is roasted between 165 to 275 degrees Celsius(329 to 527 degrees Fahrenheit). The bean is roasted for a period of time ranging from about ½ to 30 minutes. The roasted bean beverage is selected from the group consisting of plain, flavored, and with addition of ingredient.

Distilled water is created by distillation which involves boiling water and then condensing steam in order to remove impurities. The distilled water can be created with addition of ingredient.

Mineral water is water from a mineral spring containing various minerals including salts and sulfur compounds. The mineral water can be created with addition of ingredient.

Sports drink is created by mixing water, sugar, and electrolyte. The sugar is about 4 and 5 heaped teaspoons of sugar per five ounce (13 and 19 grams per 250 ml) serving for isotonic. The electrolyte is selected from the group consisting of sodium, potassium, calcium, magnesium, chloride, hydrogen phosphate, and hydrogen carbonate. The sports drink is selected from the group consisting of isotonic, hypertonic, and hypotonic. The isotonic sports drink contains similar concentrations of sugar and salt as in human body. The hypertonic sport drink contains a higher concentration of salt and sugar than human body. The hypotonic sport drink contains a lower concentration of salt and sugar than human body. The sports drink is designed to help athletes rehydrate when fluids are depleted after training and competition. The sports drink can have flavoring selected from the group consisting of natural flavor, artificial flavor, fruit flavor, flower flavor, flower bud flavor, pollen flavor, leaf flavor, stem flavor, stem shoot flavor, bulb flavor, plant flavor, plant oil flavor, root flavor, herb flavor, tea flavor, nut flavor, seed flavor, bean flavor, cereal grain flavor, fruit skin flavor, vegetable skin flavor, vegetable flavor, and vegetable oil flavor. The sports drink can be created with addition of ingredient.

Fruit juice is created by method selected from the group consisting of cutting fruit, squeezing fruit, squeezing interior of fruit, and removing any residue. The fruit juice is selected from the group consisting of plain, flavored, and with addition of ingredient.

Vegetable juice is created by method selected from the group consisting of cutting vegetable, squeezing vegetable, squeezing interior of vegetable, and removing any residue. The vegetable is selected from the group consisting of root vegetable, fruit vegetable, flower bud, flower, stem shoot, stem, leaf, bulb, cereal grain, nut, seed, bean, and sea vegetable. The vegetable juice is selected from the group consisting of plain, flavored, and with addition of ingredient.

Fruit drink is created by method selected from group consisting of cutting fruit into small pieces, grinding fruit into small particles, boiling for about 15 to 60 minutes, removing any residue, and allowing to cool. The fruit drink is selected from the group consisting of plain, flavored, and with addition of ingredient.

Vegetable drink is created by method selected from the group consisting of cutting vegetable into small pieces, grinding vegetable into small particles, boiling for about 15 to 60 minutes, removing any residue, and allowing to cool. The vegetable is selected from group consisting of root vegetable, fruit vegetable, flower bud, flower, stem shoot, stem, leaf, bulb, cereal grain, nut, seed, bean, and sea vegetable. The vegetable drink is selected from the group consisting of plain, flavored, and with addition of ingredient.

Fruit skin drink is created by peeling outer layer of fruit, boiling for about 15 to 60 minutes, removing any residue, and allowing to cool. The fruit skin drink is selected from the group consisting of plain, flavored, and with addition of ingredient.

Vegetable skin drink is created by peeling outer layer of vegetable, boiling for about 15 to 60 minutes, removing any residue, and allowing to cool. The vegetable is selected from the group consisting of root vegetable, fruit vegetable, flower bud, flower, stem shoot, stem, leaf, bulb, cereal grain, nut, seed, bean, and sea vegetable. The vegetable skin drink is selected from the group consisting of plain, flavored, and with addition of ingredient.

Plant drink is created by method selected from the group consisting of cutting plant into small pieces, grinding plant into small particles, boiling for about 15 to 60 minutes, removing any residue, and allowing to cool. The plant is selected from the group consisting of leaf, flower, flower bud, pollen, bulb, root, stem, stem shoot, and herb. The plant drink is selected from the group consisting of plain, flavored, and with addition of ingredient.

Soft drink is created by mixture selected from the group consisting of water, sweetener, flavoring, caffeine, coloring, preservative, addition of ingredient, and dissolved gas to be applied with pressure. The sweetener is selected from the group consisting of sugar, high fructose corn syrup, maple syrup, syrup, honey, butterscotch, caramel, fruit juice, sugar substitute, and artificial sweetener. The flavoring is selected from the group consisting of natural flavor, artificial flavor, fruit flavor, flower flavor, flower bud flavor, pollen flavor, leaf flavor, stem flavor, stem shoot flavor, bulb flavor, plant flavor, plant oil flavor, root flavor, herb flavor, tea flavor, nut flavor, seed flavor, bean flavor, cereal grain flavor, fruit skin flavor, vegetable skin flavor, vegetable flavor, vegetable oil flavor, and other flavor, including tea drink, coffee drink, milk drink, yogurt drink, malted drink, roasted cereal grain beverage, roasted nut and seed beverage, roasted bean beverage, distilled water, mineral water, sports drink, fruit juice, vegetable juice, fruit drink, vegetable drink, fruit skin drink, vegetable skin drink, plant drink, alcoholic drink, and soup drink. The dissolved gas is selected from group consisting of carbon dioxide, ozone, oxygen, and nitrogen.

Alcoholic drink is created by method selected from the group consisting of saccharification of ingredient, fermentation of ingredient, distillation of ingredient, addition of alcohol, removing any residue, and addition of ingredient. The ingredient is selected from the group consisting of natural flavor, artificial flavor, fruit flavor, flower flavor, flower bud flavor, pollen flavor, leaf flavor, stem flavor, stem shoot flavor, bulb flavor, plant flavor, plant oil flavor, root flavor, herb flavor, tea flavor, nut flavor, seed flavor, bean flavor, cereal grain flavor, fruit skin flavor, vegetable skin flavor, vegetable flavor, vegetable oil flavor, and other flavor, including tea drink, coffee drink, milk drink, yogurt drink, malted drink, roasted cereal grain beverage, roasted nut and seed beverage, roasted bean beverage, distilled water, mineral water, sports drink, fruit juice, vegetable juice, fruit drink, vegetable drink, fruit skin drink, vegetable skin drink, plant drink, soft drink, and soup drink. The alcoholic drink is created with an alcohol level of about ½ to 70 percent. The alcoholic drink is selected from the group consisting of cocktail, liquor, spirit, wine, and beer. The liquor includes berry liquor, chocolate liquor, coffee liquor, cream liquor, creme liquor, flower liquor, fruit liquor, herbal liquor, honey liquor, nut flavored liquor, seed flavored liquor, bean flavored liquor, grain flavored liquor, root liquor, plant liquor, flower bud liquor, leaf liquor, stem liquor, stem shoot liquor, bulb liquor, tea liquor, fruit skin liquor, vegetable liquor, vegetable skin liquor, syrup liquor, butterscotch liquor, caramel liquor, and whisky liquor. The spirit includes vodka, gin, baijiu, tequila, rum, whisky, brandy, and soju. The wine includes white wine, red wine, fruit wine, fruit skin wine, vegetable wine, vegetable skin wine, flower wine, flower bud wine, nut wine, seed wine, bean wine, cereal grain wine, root wine, leaf wine, stem wine, stem shoot wine, bulb wine, tea wine, plant wine, herb wine, milk wine, cream wine, honey wine, syrup wine, butterscotch wine, caramel wine, chocolate wine, coffee wine, starch wine, and champagne. The beer includes fruit beer, fruit skin beer, vegetable beer, vegetable skin beer, flower beer, flower bud beer, nut beer, seed beer, bean beer, cereal grain beer, root beer, leaf beer, stem beer, stem shoot beer, bulb beer, tea beer, plant beer, herb beer, milk beer, cream beer, honey beer, syrup beer, butterscotch beer, caramel beer, chocolate beer, and coffee beer. The alcoholic drink can be created with a low alcohol level of about ½ to 5 percent.

Soup drink is created by method selected from the group consisting of cutting ingredient into small pieces, grinding ingredient into small particles, boiling for about 15 to 180 minutes, removing any residue, allowing to cool, and addition of ingredient. The ingredient is selected from the group consisting of meat, seafood, fruit, vegetable, plant, and other ingredient. The soup drink can have flavoring selected from the group consisting of natural flavor, artificial flavor, fruit flavor, flower flavor, flower bud flavor, pollen flavor, leaf flavor, stem flavor, stem shoot flavor, bulb flavor, plant flavor, plant oil flavor, root flavor, herb flavor, tea flavor, nut flavor, seed flavor, bean flavor, cereal grain flavor, fruit skin flavor, vegetable skin flavor, vegetable flavor, vegetable oil flavor, and vegetable fat flavor.

The addition of ingredient is in form selected from the group consisting of mixed in, and topping.

At least one flavoring ingredient is selected from the group consisting of natural flavor, artificial flavor, fruit flavor, plant flavor, plant oil flavor, herb flavor, tea flavor, root flavor, flower flavor, flower bud flavor, pollen flavor, leaf flavor, stem flavor, stem shoot flavor, bulb flavor, nut flavor, seed flavor, bean flavor, cereal grain flavor, fruit skin flavor, vegetable skin flavor, vegetable flavor, vegetable oil flavor, vegetable fat flavor, meat flavor, seafood flavor, and other flavor. The at least one flavoring ingredient is selected from the group consisting of skin, skinned, unskinned, unshelled, cut, uncut, extract, juice, sauce, liquid, oil, gel, jelly, wax, cream, paste, powder, thin layer, small particles, and small pieces. The at least one flavoring ingredient can be uncooked, and cooked by method selected from the group consisting of deep frying, sun drying, roasting, baking, steaming, boiling, grilling, and frying.

For flavoring ingredient, other flavor is selected from the group consisting of artificial sweetener, salt, vinegar, sugar, syrup, honey, chocolate, apple sauce, raisin, cream, sour cream, milk, ice cream, yogurt, gelato, sherbet, cheese, cream cheese, cottage cheese, mozzarella, mascarpone, ricotta, butter, margarine, royal jelly, caramel, butterscotch, peanut butter, cookie, biscuit, cake, jelly, pudding, custard, taco, bread, pita, tortilla, pancake, crepe, pastry, waffle, donut, pie, roll, candy, marshmallow, malt, fruit, fruit skin, vegetable, vegetable skin, nut, cereal, bean, plant, herb, vegetable shortening, fish oil, fish liver oil, plant wax, animal wax, beeswax, carnauba wax, tonic water, glycerol, and egg.

For flavoring ingredient, fruit flavor and fruit skin flavor are selected from the group consisting of apple, orange, lemon, lime, grapefruit, grape, guava, plum, peach, pear, blackberry, blueberry, strawberry, cranberry, raspberry, cherry, mango, pineapple, pomegranate, papaya, watermelon, rockmelon, hamimelon, melon, honeydew, coconut, durian, passion fruit, banana, fig, apricot, mandarin, blackcurrant, starfruit, kiwi, pomelo, lychee, loquat, persimmon, tangerine, mangosteen, noni, sugar apple, mulberry, elderberry, gooseberry, lingonberry, juniper berry, jackfruit, dragonfruit, abiu, acai, acerola, ackee, cherry orange, moringa, ambarella, araza, arhat, atemoya, atherton raspberry, babaco, bacupari, bacuri, bael, barbadine, beach plum, batuan, bearberry, bignay, bilberry, bilimbi, biriba, black apple, black cherry, black raspberry, black mulberry, black sapote, blood orange, bolwarra, boquila, blue tongue, breadfruit, broad leaf bramble, buddha's hand, buffaloberry, brush cherry, burdekin plum, bush tomato, button mangosteen, caimito, calabash tree, calamondin, calamansi, camucamu, canary melon, canistel, cape gooseberry, capuli cherry, carambola, cardon, carob, cashew apple, cassabanana, cattley guava, cawesh, cedar bay cherry, ceriman, cereus peruvianus, charichuelo, chayote, che, chempedak, chenet, cherimoya, cherry ballart, chokeberry, chokecherry, chupa chupa, citron, clementine, cloudberry, cluster fig, cocky apple, coco plum, cocona, cocoplum, coffee cherry, common apple berry, conkerberry, cornelian cherry, crowberry, cupuacu, currant, curry leaf apple, custard apple, elephant apple, key apple, damson plum, date, date plum, davidson's plum, dead man's finger, desert banana, desert fig, desert lime, dodder laurel, doubah, double coconut, duku, eastern may hawthorn, emu apple, emu berry, false mastic, feijoa, fibrous satinash, finger lime, florida strangler fig, gac, galia melon, gambooge, genip, giant granadilla, otaheite gooseberry, goumi, governor's plum, montessa granadilla, yellow granadilla, greengage, grumichama, guanabana, guarana, cattley guava, pineapple guava, purple guava, strawberry guava, guavaberry, hackberry, hairless rambutan, hardy kiwi, hawthorn, hog plum, honeysuckle, horned melon, huckleberry, huito, ice cream bean, llama, lllawarra plum, imbe, jabuticaba, jambul, jatoba, jelly palm, jocote, jujube, kabosu, kaffir lime, kahikatea, kakadu lime, kakadu plum, kapok, karkalla, karonda, kei apple, kepel fruit, keule, key lime, kitembilla, korlan, kumquat, kutjera, kwai muk, lady apple, lakoocha, langsat, lanzone, lapsi, lardizabala, lemon aspen, leucaena, lillypilly, little gooseberry tree, limequat, loganberry, longan, lucuma, ma praang, mabolo, madrono, malabar plum, mamey sapote, mamoncillo, mangaba, manoao, maqui, marang, marula, mayapple, malay apple, mammee apple, maypop, medlar, melinjo, melon pear, midyim, miracle fruit, mock strawberry, purple mombin, red mombin, yellow mombin, monstera, mora de castilla, morinda, morinda citrifolia, mortiflo, mountain pepper, mountain soursop, wild plum, mundu, muntries, muscadine, muskmelon, naartjie, nageia, nance, nannyberry, naranjilla, neem, nere, nonda plum, nungu, oil palm, oregan grape, oroblanco, otaheite gooseberry, palmyra palm, pawpaw, peachpalm, peanut butter fruit, pepino, pequi, peumo, phalsa, pigeon pea, pigeon plum, pigface, pindo palm, pineapple guava, pitomba, pois doux, pommecythere, pommerac, prickly pear, prune, pulasan, pummelo, pupunha, purple apple berry, purple granadilla, quandong, queensland ebony, quince, raisin tree, rambutan, red granadilla, red mulberry, rhubarb, riberry, rimu, rollinia, rose apple, rose hip, rose leaf bramble, rose myrtle, rowan, safou, sageretia, saguaro, salak, salal, salmonberry, sandpaper fig, santol, mamey, sapodilla, fibrous satinash, saskatoonberry, saw palmetto, sea buckthorn, serviceberry, shipova, small leaf tamarind, snow berry, soncoya, servicetree, soursop, southern crabapple, spanish lime, spanish tamarind, spiny monkey orange, star apple, carambola, strawberry guava, ugni, strawberry pear, surinam cherry, sweet apple berry, sweet ganadilla, sweet lemon, sweet orange, sweet pepper, sweetsop, sycamore fig, tamarillo, tamarind, monkey tamarind, velvet tamarind, tanjong, texas persimmon, thimbleberry, totara, toyon, wampee, water apple, wax apple, wax jambu, acerola, white aspen, white mulberry, white sapote, wild grape, wild orange, wild peach, wild plum, wild mangosteen, wineberry, wolfberry, wongi, wood apple, yangmei, yellow plum, yew, youngberry, and zig zag vine.

For flavoring ingredient, vegetable flavor, vegetable skin flavor, vegetable oil flavor, and vegetable fat flavor are selected from the group consisting of root vegetable, fruit vegetable, flower bud, stem shoot, stem, leaf, bulb, cereal grain, nut, seed, bean, sea vegetable, and other types of vegetable, including aloe vera, jojoba, ahipa, arracacha, bamboo shoot, beetroot, burdock, broadleaf arrowhead, camas, canna, carrot, cassava, celeriac, chinese artichoke, daikon, earthnut pea, elephant foot yam, ensete, galangal, ginger, ginseng, hamberg parsley, horseradish, lotus root, jerusalem artichoke, jicama, mashua, parsley root, parsnip, pignut, potato, prairie turnip, radish, rutabaga, salsify, scorzonera, skirret, swede, sweet potato, taro, ti, tigernut, turmeric, turnip, ulluco, wasabi, water caltrop, water chestnut, yalcon, yam, avocado, bell pepper, bitter melon, bitter gourd, breadfruit, chayote, cucumber, ivy gourd, eggplant, aubergine, brinjal, luffa, nopal, okra, pepper, pumpkin, squash, sweet corn, sweet pepper, tinda, tomatillo, tomato, west indian gherkin, winter melon, zucchini, courgette, artichoke, broccoli, caper, cauliflower, courgette flower, globe artichoke, squash blossom, asparagus, prussian asparagus, bamboo shoot, celery, leek, wild leek, lemongrass, rhubarb, cardoon, kurrat, galangal, amaranth, arugula, beet green, bok choy, borage, broccoli rabe, brussel sprout, cabbage, catsear, celery, celtuce, chard, chaya, chickweed, chicory, chinese mallow, chive, choi sum, chrysanthemum, collard green, common purslane, corn salad, cress, dandelion, endive, fat hen, fiddlehead, fluted pumpkin, garden rocket, golden samphire, good king henry, greater plantain, kai lan, kale, komatsuna, kuka, lagos bologi, lamb's lettuce, lamb's quarters, land cress, leek, lettuce, lizard's tail, malabar spinach, melokhia, miner's lettuce, mizuna green, mustard green, napa cabbage, new zealand spinach, orache, pak choy, paracress, pea, poke, radicchio, samphire, sculpit, stridolo, sea beet, sea kale, sierra leoni bologi, soko, sorrel, spinach, summer purslane, swiss chard, tatsoi, turnip green, watercress, water spinach, wheatgrass, winter purslane, yarrow, yao choy, cardoon, chive, florence fennel, elephant garlic, garlic, garlic chive, kohlrabi, onion, pearl onion, potato onion, spring onion, tree onion, welsh onion, quamash, scallion, shallot, rice, barley, oat, barley, rye, corn, wheat, buckwheat, millet, sorghum, spelt, quinoa, chicory, molasses, beet root, fonio, palmer's grass, teff, triticale, cattail, chia, flax, grain amaranth, canihua, pitseed goosefoot, wattleseed, almond, cashew, chestnut, coconut, hazelnut, macadamia, peanut, pecan, pine nut, pistachio, walnut, acorn, brazil nut, gingko nut, shea nut, beechnut, candlenut, kurrajong, mongongo, palm nut, karuka, red bopple nut, hickory, jacknut, pepea nut, yellow walnut, cycad, munya nut, monkey puzzle nut, paradise nut, colocynth, filbert, mamoncillo, maya nut, ogbono nut, water caltrop, juniper, podocarp, cempedak, coffee, egusi, fox nut, jackfruit, malabar gourd, nutmeg, breadnut, betel nut, cola nut, pili nut, olive, drumstick, okra, pumpkin seed, sesame seed, sunflower seed, lotus seed, hemp seed, green bean, red bean, azuki bean, black bean, back eyed bean, white bean, yellow bean, common bean, broad bean, pinto bean, soybean, lima bean, kidney bean, pea bean, potato bean, dolichos bean, moth bean, mung bean, ricebean, runner bean, tepary bean, urad bean, velvet bean, winged bean, yardlong bean, chickpea, pigeon pea, snap pea, snow pea, lentil, lupin, tarwi, carob, guar, horse gram, cocoa bean, bambara groundnut, cowpea, hyacinth bean, lablab, moringa oleifera, sterculia, yam bean, alfalfa, clover, mesquite, carob, tamarind, wisteria, aonori, arame, carola, caulerpa, dabberlocks, dulse, hijiki, kombu, laver, mozuku, nori, ogonori, sea grape, sea lettuce, sea weed, wakame, truffle, mushroom, and bean sprout.

For flavoring ingredient, plant flavor, plant oil flavor,herb flavor, tea flavor, root flavor, flower flavor, flower bud flavor, pollen flavor, leaf flavor, stem flavor, stem shoot flavor, bulb flavor, nut flavor, seed flavor, bean flavor, and cereal grain flavor are selected from the group consisting of leaf, flower, flower bud, pollen, root, bulb, stem, stem shoot, and herb, including hop, menthol, cordyceps, echinacea, elder, horehound, mallow, sage, thyme, cowslip, burnet, yarrow, marsh mallow, lady's mantle, speedwell, plantain, linden flowers, wild thyme, hyssop, eucalyptus, sea buckthorn, elder blossom, verbena, lemon balm, clove, coriander, cumin, basil, dill, rosemary, parsley, fennel, oregano, allspice, catnip, wormwood, musk, chili, horseradish, turmeric, mustard, curry, wasabi, mountain mint, peppermint, spearmint, wintergreen, cinnamon, licorice, rose, jasmine, chamomile, chrysanthemum, lavender, acacia, safflower, vanilla, asafoetida, balsam, bay, buchu, birch, camphor, cannabis, caraway, calamus, cistus, citronella, clary sage,costus, cubeb, cypress, cypriol,davana, elecampane, fenugreek, fir, frankincense, galbanum, geranium, goldenrod, henna, helichrysum, hickory, juniper, ledum, litseacubeba, marjoram, melaleuca, mountain savory, mugwort, myrrh, myrtle,neroli, nutmeg, orris,palosanto, petitgrain, pine, ravensara, red cedar, rosewood, sage, sassafras,schisandra, spikenard, spruce, tea tree, tsuga, valerian, yarrow, ylangylang, zedoary, benzoin, copaiba, manuka, bergamot, patchouli, lilium, ambergris, gardenia, oakmoss, labdanum, coumarin, iris, water lily, ivy, amber, carnation, vetiver, cardamom, freesia, cyclamen, muguet, gardenia, tuberose, tonka bean,agarwood, cedarwood, sandalwood,alfafa, apple, orange, lemon, lime, grapefruit, grape, guava, plum, peach, pear, blackberry, blueberry, strawberry, cranberry, raspberry, cherry, mango, pineapple, pomegranate, papaya, watermelon, rockmelon, hamimelon, melon, honeydew, coconut, durian, passion fruit, banana, fig, apricot, mandarin, blackcurrant, starfruit, kiwi, pomelo, lychee, loquat, persimmon, tangerine, mangosteen, noni, sugar apple, mulberry, elderberry, gooseberry, lingonberry, juniper berry, jackfruit, dragonfruit, abiu, acai, acerola, ackee, cherry orange, moringa, ambarella, araza, arhat, atemoya, atherton raspberry, babaco, bacupari, bacuri, bael, barbadine, beach plum, batuan, bearberry, bignay, bilberry, bilimbi, biriba, black apple, black cherry, black raspberry, black mulberry, black sapote, blood orange, bolwarra, boquila, blue tongue, breadfruit, broad leaf bramble, buddha's hand, buffaloberry, brush cherry, burdekin plum, bush tomato, button mangosteen, caimito, calabash tree, calamondin, calamansi, camucamu, canary melon, canistel, cape gooseberry, capuli cherry, carambola, cardon, carob, cashew apple, cassabanana, cattley guava, cawesh, cedar bay cherry, ceriman, cereus peruvianus, charichuelo, chayote, che, chempedak, chenet, cherimoya, cherry ballart, chokeberry, chokecherry, chupa chupa, citron, clementine, cloudberry, cluster fig, cocky apple, coco plum, cocona, cocoplum, coffee cherry, common apple berry, conkerberry, cornelian cherry, crowberry, cupuacu, currant, curry leaf apple, custard apple, elephant apple, key apple, damson plum, date, date plum, davidson's plum, dead man's finger, desert banana, desert fig, desert lime, dodder laurel, doubah, double coconut, duku, eastern may hawthorn, emu apple, emu berry, false mastic, feijoa, fibrous satinash, finger lime, florida strangler fig, gac, galia melon, gambooge, genip, giant granadilla, otaheite gooseberry, goumi, governor's plum, montessa granadilla, yellow granadilla, greengage, grumichama, guanabana, guarana, cattley guava, pineapple guava, purple guava, strawberry guava, guavaberry, hackberry, hairless rambutan, hardy kiwi, hawthorn, hog plum, honeysuckle, horned melon, huckleberry, huito, ice cream bean, llama, lllawarra plum, imbe, jabuticaba, jambul, jatoba, jelly palm, jocote, jujube, kabosu, kaffir lime, kahikatea, kakadu lime, kakadu plum, kapok, karkalla, karonda, kei apple, kepel fruit, keule, key lime, kitembilla, korlan, kumquat, kutjera, kwai muk, lady apple, lakoocha, langsat, lanzone, lapsi, lardizabala, lemon aspen, leucaena, lillypilly, little gooseberry tree, limequat, loganberry, longan, lucuma, ma praang, mabolo, madrono, malabar plum, mamey sapote, mamoncillo, mangaba, manoao, maqui, marang, manila, mayapple, malay apple, mammee apple, maypop, medlar, melinjo, melon pear, midyim, miracle fruit, mock strawberry, purple mombin, red mombin, yellow mombin, monstera, mora de castilla, morinda, morinda citrifolia, mortillo, mountain pepper, mountain soursop, wild plum, mundu, muntries, muscadine, muskmelon, naartjie, nageia, nance, nannyberry, naranjilla, neem, nere, nonda plum, nungu, oil palm, oregan grape, oroblanco, otaheite gooseberry, palmyra palm, pawpaw, peachpalm, peanut butter fruit, pepino, pequi, peumo, phalsa, pigeon pea, pigeon plum, pigface, pindo palm, pineapple guava, pitomba, pois doux, pommecythere, pommerac, prickly pear, prune, pulasan, pummelo, pupunha, purple apple berry, purple granadilla, quandong, queensland ebony, quince, raisin tree, rambutan, red granadilla, red mulberry, rhubarb, riberry, rimu, rollinia, rose apple, rose hip, rose leaf bramble, rose myrtle, rowan, safou, sageretia, saguaro, salak, salal, salmonberry, sandpaper fig, santol, mamey, sapodilla, fibrous satinash, saskatoonberry, saw palmetto, sea buckthorn, serviceberry, shipova, small leaf tamarind, snow berry, soncoya, servicetree, soursop, southern crabapple, spanish lime, spanish tamarind, spiny monkey orange, star apple, carambola, strawberry guava, ugni, strawberry pear, surinam cherry, sweet apple berry, sweet ganadilla, sweet lemon, sweet orange, sweet pepper, sweetsop, sycamore fig, tamarillo, tamarind, monkey tamarind, velvet tamarind, tanjong, texas persimmon, thimbleberry, totara, toyon, wampee, water apple, wax apple, wax jambu, acerola, white aspen, white mulberry, white sapote, wild grape, wild orange, wild peach, wild plum, wild mangosteen, wineberry, wolfberry, wongi, wood apple, yangmei, yellow plum, yew, youngberry, zig zag vine, ahipa, arracacha, bamboo shoot, beetroot, burdock, broadleaf arrowhead, camas, canna, carrot, cassava, celeriac, chinese artichoke, daikon, earthnut pea, elephant foot yam, ensete, galangal, ginger, ginseng, hamberg parsley, lotus root, jerusalem artichoke, jicama, mashua, parsley root, parsnip, pignut, potato, prairie turnip, radish, rutabaga, salsify, scorzonera, skirret, swede, sweet potato, taro, ti, tigernut, turnip, ulluco, wasabi, water caltrop, water chestnut, yalcon, yam, avocado, bell pepper, bitter melon, bitter gourd, breadfruit, chayote, cucumber, ivy gourd, eggplant, aubergine, brinjal, luffa, nopal, okra, pepper, pumpkin, squash, sweet corn, sweet pepper, tinda, tomatillo, tomato, west indian gherkin, winter melon, zucchini, courgette, artichoke, broccoli, caper, cauliflower, courgette flower, globe artichoke, squash blossom, asparagus, prussian asparagus, bamboo shoot, celery, leek, wild leek, lemongrass, rhubarb, cardoon, kurrat, galangal, amaranth, arugula, beet green, bok choy, borage, broccoli rabe, brussel sprout, cabbage, catsear, celery, celtuce, chard, chaya, chickweed, chicory, chinese mallow, chive, choi sum, collard green, common purslane, corn salad, cress, dandelion, endive, fat hen, fiddlehead, fluted pumpkin, garden rocket, golden samphire, good king henry, greater plantain, kai lan, kale, komatsuna, kuka, lagos bologi, lamb's lettuce, lamb's quarters, land cress, leek, lettuce, lizard's tail, malabar spinach, melokhia, miner's lettuce, mizuna green, mustard green, napa cabbage, new zealand spinach, orache, pak choy, paracress, pea, poke, radicchio, samphire, sculpit, stridolo, sea beet, sea kale, sierra leoni bologi, soko, sorrel, spinach, summer purslane, swiss chard, tatsoi, turnip green, watercress, water spinach, wheatgrass, winter purslane, yarrow, yao choy, cardoon, chive, florence fennel, elephant garlic, garlic, garlic chive, kohlrabi, onion, pearl onion, potato onion, spring onion, tree onion, welsh onion, quamash, scallion, shallot, rice, barley, oat, barley, rye, corn, wheat, buckwheat, millet, sorghum, spelt, quinoa, chicory, molasses, beet root, fonio, palmer's grass, teff, triticale, cattail, chia, flax, grain amaranth, canihua, pitseed goosefoot, wattleseed, almond, cashew, chestnut, coconut, hazelnut, macadamia, peanut, pecan, pine nut, pistachio, walnut, acorn, brazil nut, gingko nut, shea nut, beechnut, candlenut, kurrajong, mongongo, palm nut, karuka, red bopple nut, hickory, jacknut, pepea nut, yellow walnut, cycad, munya nut, monkey puzzle nut, paradise nut, colocynth, filbert, mamoncillo, maya nut, ogbono nut, water caltrop, juniper, podocarp, cempedak, coffee, egusi, fox nut, jackfruit, malabar gourd, nutmeg, breadnut, betel nut, cola nut, pili nut, olive, drumstick, okra, pumpkin seed, sesame seed, sunflower seed, lotus seed, hemp seed, green bean, red bean, azuki bean, black bean, back eyed bean, white bean, yellow bean, common bean, broad bean, pinto bean, soybean, lima bean, kidney bean, pea bean, potato bean, dolichos bean, moth bean, mung bean, ricebean, runner bean, tepary bean, urad bean, velvet bean, winged bean, yardlong bean, chickpea, pigeon pea, snap pea, snow pea, lentil, lupin, tarwi, carob, guar, horse gram, cocoa bean, coffee bean, bambara groundnut, cowpea, hyacinth bean, lablab, moringa oleifera, sterculia, yam bean, alfalfa, clover, mesquite, carob, tamarind, wisteria, aonori, arame, carola, caulerpa, dabberlocks, dulse, hijiki, kombu, laver, mozuku, nori, ogonori, sea grape, sea lettuce, sea weed, wakame, truffle, mushroom, bean sprout, acai, aloe vera, arnica, ashoka, asthma weed, astragalus, barberry, belladonna, bitter leaf, bitter orange, black cohosh, blessed thistle, cat's claw, cayenne, chaparral, chasteberry, cinchona, coffee senna, comfrey, digitalis, dong quai, ephedra, european mistletoe, evening primrose, fenugreek, feverfew, flaxseed, gingko, goldenseal, hoodia, horse chestnut, horsetail, jamaica dogwood, jojoba, kava, khat, konjac, kratom, kanna, licorice root, marigold, moringa oleifera, milk thistle, neem, opium poppy, purple coneflower, passion flower, red clover, syrian rue, st john's wort, saw palmetto, tea tree oil, thunder god vine, tulasi, turmeric, umckaloabo, valerian, white willow, yerba santa, ajwain, akudjura, alexanders, alkanet, alligator pepper, angelica, anise, anise hyssop, aniseed myrtle, annatto, apple mint, artemisia, asafoetida, asarabacca, avens, avocado leaf, barberry, bay leaf, bee balm, boldo, borage, black cardamom, blue fenugreek, caraway, cardamom, cassia, cayenne pepper, celery leaf, celery seed, chervil, chicory, cicely, cilantro, clary, costmary, cubeb pepper, cudweed, culantro, curry leaf, curry plant, dill seed, epazote, fenugreek, filé powder, fingerroot, galangal, galingale, ganoderma, golpar, grains of paradise, grains of selim, houttuynia cordata, huacatay, indonesian bay leaf, jimbu, kaffir lime leaves, kala zeera, kawakawa seeds, kencur, keluak, kinh gioi, kokam seed, korarima, koseret leaves, lemon myrtle, lemon ironbark, lemon verbena, leptotes bicolor, lesser calamint, lime flower, lovage, mahlab, marjoram, mastic, mountain horopito, musk mallow, nasturtium, nigella, njangsa, neem, olida, orris root, pandan flower, pandan leaf, paprika, paracress, peppermint gum leaf, perilla, pandanus amaryllifolius, quassia, ramsons, rice paddy herb, rue, saffron, salad burnet, salep, sassafras, savory, silphium, shiso, sorrel, spikenard, star anise, sumac, sweet woodruff, tarragon, voatsiperifery, water-pepper, wattleseed, wild betel, willow herb, wood avens, and woodruff.

For flavoring ingredient, vegetable oil flavor is selected from the group consisting of corn oil, canola oil, peanut oil, olive oil, coconut oil, soybean oil, sesame oil, sunflower oil, flaxseed oil, grape seed oil, pumpkin seed oil, safflower oil, argan oil, rice bran oil, palm oil, palm kernel oil, almond oil, avocado oil, cottonseed oil, hemp oil, mustard oil, macadamia oil, groundnut oil, teaseed oil, walnut oil, cashew oil, castor oil, colza oil, hazelnut oil, linseed oil, manila oil, mongongo nut oil, mustard oil, pecan oil, perilla oil, pine nut oil, pistachio oil, poppyseed oil, rapeseed oil, jojoba oil, and watermelon seed oil.

For flavoring ingredient, meat flavor is selected from the group consisting of chicken, duck, goose, turkey, quail, rabbit, sheep, goat, cow, pig, deer, bison, buffalo, crocodile, frog, turtle, snail, worm, bacon, sausage, animal tissue, animal organ, animal tongue, animal tail, animal feet, animal liver, animal stomach, animal intestine, animal brain, animal heart, animal skin, animal tendon, animal fat, animal bone marrow, and animal blood.

For flavoring ingredient, seafood flavor is selected from the group consisting of squid, cuttle fish, shrimp, crab, crayfish, octopus, clam, oyster, scallop, lobster, abalone, conch, jellyfish, prawn, hill, mussel, sea cucumber, sea urchin, eel, snail, shrimp roe, crab roe, lobster roe, fish roe, and fish.

At least one nutritional ingredient comprises essential nutrient selected from the group consisting of vitamin, dietary mineral, amino acid, and fatty acid. The vitamin includes vitamin A, vitamin B1, vitamin B2, vitamin B3, vitamin B5, vitamin B6, vitamin B7, vitamin B9, vitamin B12, vitamin C, vitamin D, vitamin E, and vitamin K. The dietary mineral includes calcium, phosphorus, potassium, sulfur, sodium, chlorine, magnesium, iron, cobalt, copper, zinc, molybdenum, iodine, selenium, manganese, nickle, chromium, fluorine, boron, and strontium. The amino acid includes histidine, isoleucine, leucine, lysine, methionine, cysteine, phenylalanine, tyrosine, threonine, tryptophan, and valine. The fatty acid includes alpha-linoleic acid(an omega-3 fatty acid) and linoleic acid(an omega-6 fatty acid). The at least one nutritional ingredient is in form selected from the group consisting of extract, juice, sauce, liquid, oil, gel, jelly, wax, cream, paste, powder, thin layer, small particles, and small pieces.

At least one health ingredient comprises medication and other health ingredient. The medication is mixed into the beverage for ease of consumption. Other health ingredient is selected from the group consisting of electrolyte, lactase, yeast, propolis, and quinine. The at least one health ingredient is in form selected from the group consisting of extract, juice, sauce, liquid, oil, gel, jelly, wax, cream, paste, powder, thin layer, small particles, and small pieces.

At least one other ingredient comprises food additive is selected from group consisting of acid, acidity regulator, alcohol, anticaking agent, antifoaming agent, antioxidant, bulking agent, coagulation agent, food coloring, color retention agent, emulsifier, flavor enhancer, flour treatment agent, gelling agent, glazing agent, humectant, leavening agent, tracer gas, preservative, stabilizer, sweetener, tenderizer, and thickener.

The beverage system is packaged as individual package and multiple package. The packaging can be in air tight container. And the packaging is selected from the group consisting of paper, plastic, metal, and glass.

It should be noted that the steps described in the method of use can be carried out in many different orders according to user preference. The use of “step of” should not be interpreted as “step for”, in the claims herein and is not intended to invoke the provisions of 35 U.S.C. §112, ⇑6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent set forth in the appended claims:

1. A beverage system comprising:
beverage, with
at least one liquid;
wherein said beverage is created in variety selected from group consisting of tea drink, coffee drink, milk drink, yogurt drink, malted drink, roasted cereal grain beverage, roasted nut and seed beverage, roasted bean beverage, distilled water, mineral water, sports drink, fruit juice, vegetable juice, fruit drink, vegetable drink, fruit skin drink, vegetable skin drink, plant drink, soft drink, alcoholic drink, and soup drink;
wherein said beverage is created without addition of an ingredient;
wherein said beverage is created with addition of said ingredient selected from group consisting of at least one flavoring ingredient, at least one nutritional ingredient, at least one health ingredient, and at least one other said ingredient;
wherein said beverage is served in manner selected from group consisting of hot drink, cold drink, drink with ice, and warm drink;
wherein said beverage is selected from group consisting of caffeinated, and non caffeinated;
wherein said beverage is selected from group consisting of diet, and non diet; and
wherein said at least one liquid is in form selected from group consisting of water, oil, and alcohol.

2. The beverage system of claim 1 wherein said beverage is created in form selected from group consisting of bubble beverage, instant beverage, and beverage with dissolved gas.

3. The beverage system of claim 2 wherein said bubble beverage is created for consumer to consume small spherical balls mixed into said beverage selected from group consisting of tapioca balls, sago pearls, starch balls, gelatin balls, and balls with both gelatin and starch; said spherical balls having a diameter of about 1 to 10 millimeters; and said bubble beverage can be consumed with a thick drinking straw.

4. The beverage system of claim 3 wherein said small spherical balls having ingredient selected from group consisting of gelatin and starch, including gelatin from fish and animal, beaten egg, egg white, pectin, vegetable gum, vegetable starch, corn starch, potato starch, sago, and tapioca;said small spherical balls with gelatin from fish and animal as ingredient can be mixed into cold drink because gelatin congeals below 15 degrees Celsius; and said small spherical balls with starch, egg, and egg white as ingredient can be mixed into cold drink, warm drink, and hot drink.

5. The beverage system of claim 2 wherein said instant beverage is created for consumer to have the convenience to make said beverage from a form selected from group consisting of solid medium in particles, and condensed liquid medium.

6. The beverage system of claim 5 wherein said solid medium in particles can be dissolved in hot water for consumption; said solid medium in particles can be created by method selected from group consisting of drying said beverage into soluble powder, freeze drying said beverage into granules, and spray drying said beverage into granules; said condensed liquid medium can be mixed with water for consumption; and said condensed liquid medium can be created by applying heat to vaporize water.

7. The beverage system of claim 2 wherein said beverage with dissolved gas is created for consumer to consume said beverage with dissolved gas selected from group consisting of carbon dioxide, ozone, oxygen, and nitrogen; and said beverage with dissolved gas is in form selected from group consisting of carbonated, ozonated, oxygenated, and nitrogenated.

8. The beverage system of claim 7 wherein said dissolved gas is added to said beverage by method selected from group consisting of application of pressure, and adding water with said dissolved gas; and said dissolved gas is released from said beverage when pressure is reduced as effervescence.

9. The beverage system of claim 1 wherein said beverage is created by mixing more than one of said beverage selected from group consisting of at least one said tea drink, at least one said coffee drink, at least one said milk drink, at least one said yogurt drink, at least one said malted drink, at least one said roasted cereal grain beverage, at least one said roasted nut and seed beverage, at least one said roasted bean beverage, said distilled water, at least one said mineral water, at least one said sports drink, at least one said fruit juice, at least one said vegetable juice, at least one said fruit drink, at least one said vegetable drink, at least one said fruit skin drink, at least one said vegetable skin drink, at least one said plant drink, at least one said soft drink, at least one said alcoholic drink, and at least one said soup drink.

10. The beverage system of claim 1 wherein said tea drink is created by method selected from group consisting of peeling skin of ingredient, cutting ingredient into small pieces, grinding said ingredient into small particles, drying said ingredient by heat, drying said ingredient by sun, dry roasting said ingredient, placing said ingredient in tea bag, placing said ingredient in container, mixing boiling water with said ingredient, steeping said ingredient in boiling water, and removing any residue; said ingredient is selected from group consisting of leaf, flower, flower bud, pollen, stem, stem shoot, root, bulb, cereal grain, nut, seed, bean, herb, plant, mushroom, fruit, fruit skin, vegetable, and vegetable skin; and said tea drink is selected from group consisting of white tea, yellow tea, green tea, black tea, oolong tea, earl grey, darjeeling, flower tea, root tea, herbal tea, mushroom tea, fruit tea, fruit skin tea, vegetable tea, vegetable skin tea, flavored tea, and tea with said addition of said ingredient.

11. The beverage system of claim 1 wherein said coffee drink is created by brewing one and more of roasted coffee bean; said coffee bean is roasted between 165 to 275 degrees Celsius; said coffee bean is roasted for a period of time ranging from about ½ to 30 minutes; said coffee drink having flavoring selected from group consisting of natural flavor, artificial flavor, fruit flavor, flower flavor, flower bud flavor, pollen flavor, leaf flavor, stem flavor, stem shoot flavor, bulb flavor, plant flavor, plant oil flavor, root flavor, herb flavor, tea flavor, nut flavor, seed flavor, bean flavor, cereal grain flavor, fruit skin flavor, vegetable skin flavor, vegetable flavor, and vegetable oil flavor; and said coffee drink is selected from group consisting of black coffee, latte, cappuccino, espresso, mocha, frappe, cafe au lait, flavored coffee, and coffee with said addition of said ingredient.

12. The beverage system of claim 1 wherein said milk drink is created by method selected from group consisting of extracting milk from mammal, pasteurizing milk by heating milk to about 80 degrees Celsius, boiling plant ingredient and removing residue, grinding and boiling plant ingredient and removing residue, grinding and blending plant ingredient and removing residue, and mixing both mammal milk and plant milk; said mammal is selected from group consisting of cattle, buffalo, bison, sheep, goat, elk, yak, ewe, mare, water buffalo, horse, reindeer, and camel;
said plant ingredient is selected from group consisting of cereal grain, nut, seed, and bean; said cereal grain is selected from group consisting of rice, barley, oat, barley, rye, corn, wheat, buckwheat, millet, sorghum, spelt, quinoa, chicory, molasses, beet root, fonio, palmer's grass, teff, triticale, cattail, chia, flax, grain amaranth, canihua, pitseed goosefoot, and wattleseed; said nut and seed are selected from group consisting of almond, cashew, chestnut, coconut, hazelnut, macadamia, peanut, pecan, pine nut, pistachio, walnut, acorn, brazil nut, gingko nut, beechnut, candlenut, kurrajong, mongongo, palm nut, karuka, red bopple nut, hickory, jacknut, pepea nut, yellow walnut, cycad, munya nut, monkey puzzle nut, paradise nut, colocynth, filbert, mamoncillo, maya nut, ogbono nut, water caltrop, juniper, podocarp, cempedak, coffee, egusi, fox nut, jackfruit, malabar gourd, nutmeg, breadnut, betel nut, cola nut, pili nut, olive, drumstick, okra, pumpkin seed, sesame seed, sunflower seed, lotus seed, and hemp seed; said bean is selected from group consisting of green bean, red bean, azuki bean, black bean, back eyed bean, white bean, yellow bean, common bean, broad bean, pinto bean, soybean, lima bean, kidney bean, pea bean, potato bean, dolichos bean, moth bean, mung bean, ricebean, runner bean, tepary bean, urad bean, velvet bean, winged bean, yardlong bean, chickpea, pigeon pea, snap pea, snow pea, lentil, lupin, tarwi, carob, guar, horse gram, cocoa bean, coffee bean, bambara groundnut, cowpea, hyacinth bean, lablab, moringa oleifera, sterculia, yam bean, alfalfa, clover, mesquite, carob, tamarind, and wisteria; said milk drink can have flavoring selected from group consisting of natural flavor, artificial flavor, fruit flavor, flower flavor, flower bud flavor, pollen flavor, leaf flavor, stem flavor, stem shoot flavor, bulb flavor, plant flavor, plant oil flavor,root flavor, herb flavor, tea flavor, nut flavor, seed flavor, bean flavor, cereal grain flavor, fruit skin flavor, vegetable skin flavor, vegetable flavor, and vegetable oilflavor; and said milk drink is selected from group consisting of said mammal milk, plant milk, whole milk, low fat milk, non fat milk, lactaid milk, chocolate milk, buttermilk, malted milk, flavored milk, and milk with said addition of said ingredient.

13. The beverage system of claim 1 wherein said yogurt drink is created by method selected from group consisting of heating milk to about 80 degrees Celsius for a pasteurization process to kill any undesirable bacteria and to denature milk proteins so that they set together rather than form curds, cooling milk to about 45 degrees Celsius, adding bacterial culture for bacterial fermentation of milk, and allowing 4 to 7 hours for fermentation; said bacterial fermentation of milk selected from group consisting of mammal milk, and plant milk; said mammal milk is extracted from mammal selected from group consisting of cattle, buffalo, bison, sheep, goat, elk, yak, ewe, mare, water buffalo, horse, reindeer, and camel; said plant milk is created from plant ingredient selected from group consisting of cereal grain, nut, seed, and bean; said cereal grain is selected from group consisting of rice, barley, oat, barley, rye, corn, wheat, buckwheat, millet, sorghum, spelt, quinoa, chicory, molasses, beet root, fonio, palmer's grass, teff, triticale, cattail, chia, flax, grain amaranth, canihua, pitseed goosefoot, and wattleseed; said nut and seed are selected from group consisting of almond, cashew, chestnut, coconut, hazelnut, macadamia, peanut, pecan, pine nut, pistachio, walnut, acorn, brazil nut, gingko nut, beechnut, candlenut, kurrajong, mongongo, palm nut, karuka, red bopple nut, hickory, jacknut, pepea nut, yellow walnut, cycad, munya nut, monkey puzzle nut, paradise nut, colocynth, filbert, mamoncillo, maya nut, ogbono nut, water caltrop, juniper, podocarp, cempedak, coffee, egusi, fox nut, jackfruit, malabar gourd, nutmeg, breadnut, betel nut, cola nut, pili nut, olive, drumstick, okra, pumpkin seed, sesame seed, sunflower seed, lotus seed, and hemp seed; said bean is selected from group consisting of green bean, red bean, azuki bean, black bean, back eyed bean, white bean, yellow bean, common bean, broad bean, pinto bean, soybean, lima bean, kidney bean, pea bean, potato bean, dolichos bean, moth bean, mung bean, ricebean, runner bean, tepary bean, urad bean, velvet bean, winged bean, yardlong bean, chickpea, pigeon pea, snap pea, snow pea, lentil, lupin, tarwi, carob, guar, horse gram, cocoa bean, coffee bean, bambara groundnut, cowpea, hyacinth bean, lablab, moringa oleifera, sterculia, yam bean, alfalfa, clover, mesquite, carob, tamarind, and wisteria; said plant milk is created by method selected from group consisting of boiling plant ingredient and removing residue, grinding and boiling plant ingredient and removing residue, grinding and blending plant ingredient and removing residue; said yogurt drink can have flavoring selected from group consisting of natural flavor, artificial flavor, fruit flavor, flower flavor, flower bud flavor, pollen flavor, leaf flavor, stem flavor, stem shoot flavor, bulb flavor, plant flavor, plant oil flavor, root flavor, herb flavor, tea flavor, nut flavor, seed flavor, bean flavor, cereal grain flavor, fruit skin flavor, vegetable skin flavor, vegetable flavor, and vegetable oil flavor; and said yogurt drink is selected from group consisting of plain yogurt drink, flavored yogurt drink, and yogurt drink with said addition of said ingredient.

14. The beverage system of claim 1 wherein said malted drink is created by method selected from group consisting of germinating cereal grain, soaking in water, drying with hot air, turning into malt enzyme, using malt for brewing, using malted extract for adding into drink, and removing any residue; said cereal grain is selected from group consisting of rice, barley, oat, barley, rye, corn, wheat, buckwheat, millet, sorghum, spelt, quinoa, chicory, molasses, beet root, fonio, palmer's grass, teff, triticale, cattail, chia, flax, grain amaranth, canihua, pitseed goosefoot, and wattleseed; and said malted drink is selected from group consisting of beer, non alcoholic beer, ale, lager, and beverage made with malted extract, including malted milk, malted mammal milk, malted plant milk, malted milkshake, malted yogurt, malted coffee, malted tea, malted roasted cereal grain beverage, malted roasted nut and seed beverage, malted roasted bean beverage, malted sports drink, malted fruit juice, malted vegetable juice, malted fruit drink, malted vegetable drink, malted fruit skin drink, malted vegetable skin drink, malted plant drink, malted soft drink, malted alcoholic drink, malted soup drink, and malted drink with said addition of said ingredient.

15. The beverage system of claim 1 wherein said roasted cereal grain beverage is created by brewing one and more of roasted cereal grain; said cereal grain is selected from group consisting of rice, barley, oat, barley, rye, corn, wheat, buckwheat, millet, sorghum, spelt, quinoa, chicory, molasses, beet root, fonio, palmer's grass, teff, triticale, cattail, chia, flax, grain amaranth, canihua, pitseed goosefoot, and wattleseed; said cereal grain is roasted between 165 to 275 degrees Celsius; said cereal grain is roasted for a period of time ranging from about ½ to 30 minutes; and said roasted cereal grain beverage is selected from group consisting of plain, flavored, and with said addition of said ingredient.

16. The beverage system of claim 1 wherein said roasted nut and seed beverage is created by brewing one and more of roasted nut; said nut and seed are selected from group consisting of almond, cashew, chestnut, coconut, hazelnut, macadamia, peanut, pecan, pine nut, pistachio, walnut, acorn, brazil nut, gingko nut, beechnut, candlenut, kurrajong, mongongo, palm nut, karuka, red bopple nut, hickory, jacknut, pepea nut, yellow walnut, cycad, munya nut, monkey puzzle nut, paradise nut, colocynth, filbert, mamoncillo, maya nut, ogbono nut, water caltrop, juniper, podocarp, cempedak, coffee, egusi, fox nut, jackfruit, malabar gourd, nutmeg, breadnut, betel nut, cola nut, pili nut, olive, drumstick, okra, pumpkin seed, sesame seed, sunflower seed, lotus seed, and hemp seed; said nut and seed are roasted between 165 to 275 degrees Celsius;
said nut and seed are roasted for a period of time ranging from about ½ to 30 minutes; and said roasted nut and seed beverage is selected from group consisting of plain, flavored, and with said addition of said ingredient.

17. The beverage system of claim 1 wherein said roasted bean beverage is created by brewing one and more of roasted bean; said bean is selected from group consisting of green bean, red bean, azuki bean, black bean, back eyed bean, white bean, yellow bean, common bean, broad bean, pinto bean, soybean, lima bean, kidney bean, pea bean, potato bean, dolichos bean, moth bean, mung bean, ricebean, runner bean, tepary bean, urad bean, velvet bean, winged bean, yardlong bean, chickpea, pigeon pea, snap pea, snow pea, lentil, lupin, tarwi, carob, guar, horse gram, cocoa bean, coffee bean, bambara groundnut, cowpea, hyacinth bean, lablab, moringa oleifera, sterculia, yam bean, alfalfa, clover, mesquite, carob, tamarind, and wisteria; said bean is roasted between 165 to 275 degrees Celsius; said bean is roasted for a period of time ranging from about ½ to 30 minutes; and said roasted bean beverage is selected from group consisting of plain, flavored, and with said addition of said ingredient.

18. The beverage system of claim 1 wherein said distilled water is created by distillation which involves boiling water and then condensing steam in order to remove impurities; and said distilled water can be created with said addition of said ingredient.

19. The beverage system of claim 1 wherein said mineral water is water from a mineral spring containing various minerals including salts and sulfur compounds; and said mineral water can be created with said addition of said ingredient.

20. The beverage system of claim 1 wherein said sports drink is created by mixing water, sugar, and electrolyte; said sugar is about 4 and 5 heaped teaspoons of sugar per five ounce serving for isotonic; said electrolyte is selected from group consisting of sodium, potassium, calcium, magnesium, chloride, hydrogen phosphate, and hydrogen carbonate; said sports drink is selected from group consisting of isotonic, hypertonic, and hypotonic; said isotonic sports drink contains similar concentrations of sugar and salt as in human body; said hypertonic sport drink contains a higher concentration of salt and sugar than human body; said hypotonic sport drink contains a lower concentration of salt and sugar than human body; said sports drink is designed to help athletes rehydrate when fluids are depleted after training and competition; said sports drink having flavoring selected from group consisting of natural flavor, artificial flavor, fruit flavor, flower flavor, flower bud flavor, pollen flavor, leaf flavor, stem flavor, stem shoot flavor, bulb flavor, plant flavor, plant oil flavor, root flavor, herb flavor, tea flavor, nut flavor, seed flavor, bean flavor, cereal grain flavor, fruit skin flavor, vegetable skin flavor, vegetable flavor, and vegetable oil flavor; and said sports drink can be created with said addition of said ingredient.

21. The beverage system of claim 1 wherein said fruit juice is created by method selected from group consisting of cutting fruit, squeezing fruit, squeezing interior of fruit, and removing any residue; and said fruit juice is selected from group consisting of plain, flavored, and with said addition of said ingredient.

22. The beverage system of claim 1 wherein said vegetable juice is created by method selected from group consisting of cutting vegetable, squeezing vegetable, squeezing interior of vegetable, and removing any residue; said vegetable is selected from group consisting of root vegetable, fruit vegetable, flower bud, flower, stem shoot, stem, leaf, bulb, cereal grain, nut, seed, bean, and sea vegetable; and said vegetable juice is selected from group consisting of plain, flavored, and with said addition of said ingredient.

23. The beverage system of claim 1 wherein said fruit drink is created by method selected from group consisting of cutting fruit into small pieces, grinding fruit into small particles, boiling for about 15 to 60 minutes, removing any residue, and allowing to cool; and said fruit drink is selected from group consisting of plain, flavored, and with said addition of said ingredient.

24. The beverage system of claim 1 wherein said vegetable drink is created by method selected from group consisting of cutting vegetable into small pieces, grinding vegetable into small particles, boiling for about 15 to 60 minutes, removing any residue, and allowing to cool; said vegetable is selected from group consisting of root vegetable, fruit vegetable, flower bud, flower, stem shoot, stem, leaf, bulb, cereal grain, nut, seed, bean, and sea vegetable; and said vegetable drink is selected from group consisting of plain, flavored, and with said addition of said ingredient.

25. The beverage system of claim 1 wherein said fruit skin drink is created by peeling outer layer of fruit, boiling for about 15 to 60 minutes, removing any residue, and allowing to cool; and said fruit skin drink is selected from group consisting of plain, flavored, and with said addition of said ingredient.

26. The beverage system of claim 1 wherein said vegetable skin drink is created by peeling outer layer of vegetable, boiling for about 15 to 60 minutes, removing any residue, and allowing to cool; said vegetable is selected from group consisting of root vegetable, fruit vegetable, flower bud, flower, stem shoot, stem, leaf, bulb, cereal grain, nut, seed, bean, and sea vegetable; and
said vegetable skin drink is selected from group consisting of plain, flavored, and with said addition of said ingredient.

27. The beverage system of claim 1 wherein said plant drink is created by method selected from group consisting of cutting plant into small pieces, grinding plant into small particles, boiling for about 15 to 60 minutes, removing any residue, and allowing to cool; said plant is selected from group consisting of leaf, flower, flower bud, pollen, root, bulb, stem, stem shoot, and herb; and
said plant drink is selected from group consisting of plain, flavored, and with said addition of said ingredient.

28. The beverage system of claim 1 wherein said soft drink is created by mixture selected from group consisting of water, sweetener, flavoring, caffeine, coloring, preservative, said addition of said ingredient, and dissolved gas to be applied with pressure; said sweetener is selected from group consisting of sugar, high fructose corn syrup, maple syrup, syrup, honey, butterscotch, caramel, fruit juice, sugar substitute, and artificial sweetener; said flavoring is selected from group consisting of natural flavor, artificial flavor, fruit flavor, flower flavor, flower bud flavor, pollen flavor, leaf flavor, stem flavor, stem shoot flavor, bulb flavor, plant flavor, plant oil flavor, root flavor, herb flavor, tea flavor, nut flavor, seed flavor, bean flavor, cereal grain flavor, fruit skin flavor, vegetable skin flavor, vegetable flavor, vegetable oil flavor, and other flavor, including said tea drink, said coffee drink, said milk drink, said yogurt drink, said malted drink, said roasted cereal grain beverage, said roasted nut and seed beverage, said roasted bean beverage, said distilled water, said mineral water, said sports drink, said fruit juice, said vegetable juice, said fruit drink, said vegetable drink, said fruit skin drink, said vegetable skin drink, said plant drink, said alcoholic drink, and said soup drink; and said dissolved gas is selected from group consisting of carbon dioxide, ozone, oxygen, and nitrogen.

29. The beverage system of claim 1 wherein said alcoholic drink is created by method selected from group consisting of saccharification of ingredient, fermentation of ingredient, distillation of ingredient, addition of alcohol, removing any residue, and said addition of said ingredient; said ingredient is selected from group consisting of natural flavor, artificial flavor, fruit flavor, flower flavor, flower bud flavor, pollen flavor, leaf flavor, stem flavor, stem shoot flavor, bulb flavor, plant flavor, plant oil flavor, root flavor, herb flavor, tea flavor, nut flavor, seed flavor, bean flavor, cereal grain flavor, fruit skin flavor, vegetable skin flavor, vegetable flavor, vegetable oil flavor, and other flavor, including said tea drink, said coffee drink, said milk drink, said yogurt drink, said malted drink, said roasted cereal grain beverage, said roasted nut and seed beverage, said roasted bean beverage, said distilled water, said mineral water, said sports drink, said fruit juice, said vegetable juice, said fruit drink, said vegetable drink, said fruit skin drink, said vegetable skin drink, said plant drink, said soft drink, and said soup drink; said alcoholic drink is created with an alcohol level of about ½ to 70 percent; said alcoholic drink is selected from group consisting of cocktail, liquor, spirit, wine, and beer; said liquor includes berry liquor, chocolate liquor, coffee liquor, cream liquor, creme liquor, flower liquor, fruit liquor, herbal liquor, honey liquor, nut flavored liquor, seed flavored liquor, bean flavored liquor, cereal grain flavored liquor, root liquor, plant liquor, flower bud liquor, leaf liquor, stem liquor, stem shoot liquor, bulb liquor, tea liquor, fruit skin liquor, vegetable liquor, vegetable skin liquor, syrup liquor, butterscotch liquor, caramel liquor, and whisky liquor; said spirit includes vodka, gin, baijiu, tequila, rum, whisky, brandy, and soju; said wine includes white wine, red wine, fruit wine, fruit skin wine, vegetable wine, vegetable skin wine, flower wine, flower bud wine, nut wine, seed wine, bean wine, cereal grain wine, root wine, leaf wine, stem wine, stem shoot wine, bulb wine, tea wine, plant wine, herb wine, milk wine, cream wine, honey wine, syrup wine, butterscotch wine, caramel wine, chocolate wine, coffee wine, starch wine, and champagne; said beer includes fruit beer, fruit skin beer, vegetable beer, vegetable skin beer, flower beer, flower bud beer, nut beer, seed beer, bean beer, cereal grain beer, root beer, leaf beer, stem beer, stem shoot beer, bulb beer, tea beer, plant beer, herb beer, milk beer, cream beer, honey beer, syrup beer, butterscotch beer, caramel beer, chocolate beer, and coffee beer; and said alcoholic drink is created with a low alcohol level of about ½ to 5 percent.

30. The beverage system of claim 1 wherein said soup drink is created by method selected from group consisting of cutting ingredient into small pieces, grinding ingredient into small particles, boiling for about 15 to 180 minutes, removing any residue, allowing to cool, and said addition of ingredient; said ingredient is selected from group consisting of meat, seafood, fruit, vegetable, and plant; and said soup drink can have flavoring selected from group consisting of natural flavor, artificial flavor, fruit flavor, flower flavor, flower bud flavor, pollen flavor, leaf flavor, stem flavor, stem shoot flavor, bulb flavor, plant flavor, plant oil flavor, root flavor, herb flavor, tea flavor, nut flavor, seed flavor, bean flavor, cereal grain flavor, fruit skin flavor, vegetable skin flavor, vegetable flavor, vegetable oil flavor, and vegetable fat flavor.

31. The beverage system of claim 1 wherein said addition of said ingredient is in form selected from group consisting of mixed in, and topping.

32. The beverage system of claim 1 wherein said at least one flavoring ingredient is selected from group consisting of natural flavor, artificial flavor, fruit flavor, plant flavor, plant oil flavor, herb flavor, tea flavor, root flavor, flower flavor, flower bud flavor, pollen flavor, leaf flavor, stem flavor, stem shoot flavor, bulb flavor, nut flavor, seed flavor, bean flavor, cereal grain flavor, fruit skin flavor, vegetable skin flavor, vegetable flavor, vegetable oil flavor, vegetable fat flavor, meat flavor, seafood flavor, and other flavor; said at least one flavoring ingredient is in form selected from group consisting of skin, skinned, unskinned, unshelled, cut, uncut, extract, juice, sauce, liquid, oil, gel, jelly, wax, cream, paste, powder, thin layer, small particles, and small pieces; and said at least one flavoring ingredient can be uncooked, and cooked by method selected from group consisting of deep frying, sun drying, roasting, baking, steaming, boiling, grilling, and frying.

33. The beverage system of claim 32 wherein said other flavor is selected from group consisting of artificial sweetener, salt, vinegar, sugar, syrup, honey, chocolate, apple sauce, raisin, cream, sour cream, milk, ice cream, yogurt, gelato, sherbet, cheese, cream cheese, cottage cheese, mozzarella, mascarpone, ricotta, butter, margarine, royal jelly, caramel, butterscotch, peanut butter, cookie, biscuit, cake, jelly, pudding, custard, taco, bread, pita, tortilla, pancake, crepe, pastry, waffle, donut, pie, roll, candy, marshmallow, vegetable shortening, fish oil, fish liver oil, plant wax, animal wax, beeswax, carnauba wax, tonic water, glycerol, egg, and malt.

34. The beverage system of claim 32 wherein said fruit flavor and fruit skin flavor are selected from group consisting of apple, orange, lemon, lime, grapefruit, grape, guava, plum, peach, pear, blackberry, blueberry, strawberry, cranberry, raspberry, cherry, mango, pineapple, pomegranate, papaya, watermelon, rockmelon, hamimelon, melon, honeydew, coconut, durian, passion fruit, banana, fig, apricot, mandarin, blackcurrant, starfruit, kiwi, pomelo, lychee, loquat, persimmon, tangerine, mangosteen, noni, sugar apple, mulberry, elderberry, gooseberry, lingonberry, juniper berry, jackfruit, dragonfruit, abiu, acai, acerola, ackee, cherry orange, moringa, ambarella, araza, arhat, atemoya, atherton raspberry, babaco, bacupari, bacuri, bael, barbadine, beach plum, batuan, bearberry, bignay, bilberry, bilimbi, biriba, black apple, black cherry, black raspberry, black mulberry, black sapote, blood orange, bolwarra, boquila, blue tongue, breadfruit, broad leaf bramble, buddha's hand, buffaloberry, brush cherry, burdekin plum, bush tomato, button mangosteen, caimito, calabash tree, calamondin, calamansi, camucamu, canary melon, canistel, cape gooseberry, capuli cherry, carambola, cardon, carob, cashew apple, cassabanana, cattley guava, cawesh, cedar bay cherry, ceriman, cereus peruvianus, charichuelo, chayote, che, chempedak, chenet, cherimoya, cherry ballart, chokeberry, chokecherry, chupa chupa, citron, clementine, cloudberry, cluster fig, cocky apple, coco plum, cocona, cocoplum, coffee cherry, common apple berry, conkerberry, cornelian cherry, crowberry, cupuacu, currant, curry leaf apple, custard apple, elephant apple, key apple, damson plum, date, date plum, davidson's plum, dead man's finger, desert banana, desert fig, desert lime, dodder laurel, doubah, double coconut, duku, eastern may hawthorn, emu apple, emu berry, false mastic, feijoa, fibrous satinash, finger lime, florida strangler fig, gac, galia melon, gambooge, genip, giant granadilla, otaheite gooseberry, goumi, governor's plum, montessa granadilla, yellow granadilla, greengage, grumichama, guanabana, guarana, cattley guava, pineapple guava, purple guava, strawberry guava, guavaberry, hackberry, hairless rambutan, hardy kiwi, hawthorn, hog plum, honeysuckle, horned melon, huckleberry, huito, ice cream bean, llama, lllawarra plum, imbe, jabuticaba, jambul, jatoba, jelly palm, jocote, jujube, kabosu, kaffir lime, kahikatea, kakadu lime, kakadu plum, kapok, karkalla, karonda, kei apple, kepel fruit, keule, key lime, kitembilla, korlan, kumquat, kutjera, kwai muk, lady apple, lakoocha, langsat, lanzone, lapsi, lardizabala, lemon aspen, leucaena, lillypilly, little gooseberry tree, limequat, loganberry, longan, lucuma, ma praang, mabolo, madrono, malabar plum, mamey sapote, mamoncillo, mangaba, manoao, maqui, marang, marula, mayapple, malay apple, mammee apple, maypop, medlar, melinjo, melon pear, midyim, miracle fruit, mock strawberry, purple mombin, red mombin, yellow mombin, monstera, mora de castilla, morinda, morinda citrifolia, mortiflo, mountain pepper, mountain soursop, wild plum, mundu, muntries, muscadine, muskmelon, naartjie, nageia, nance, nannyberry, naranjilla, neem, nere, nonda plum, nungu, oil palm, oregan grape, oroblanco, otaheite gooseberry, palmyra palm, pawpaw, peachpalm, peanut butter fruit, pepino, pequi, peumo, phalsa, pigeon pea, pigeon plum, pigface, pindo palm, pineapple guava, pitomba, pois doux, pommecythere, pommerac, prickly pear, prune, pulasan, pummelo, pupunha, purple apple berry, purple granadilla, quandong, queensland ebony, quince, raisin tree, rambutan, red granadilla, red mulberry, rhubarb, riberry, rimu, rollinia, rose apple, rose hip, rose leaf bramble, rose myrtle, rowan, safou, sageretia, saguaro, salak, salal, salmonberry, sandpaper fig, santol, mamey, sapodilla, fibrous satinash, saskatoonberry, saw palmetto, sea buckthorn, serviceberry, shipova, small leaf tamarind, snow berry, soncoya, servicetree, soursop, southern crabapple, spanish lime, spanish tamarind, spiny monkey orange, star apple, carambola, strawberry guava, ugni, strawberry pear, surinam cherry, sweet apple berry, sweet ganadilla, sweet lemon, sweet orange, sweet pepper, sweetsop, sycamore fig, tamarillo, tamarind, monkey tamarind, velvet tamarind, tanjong, texas persimmon, thimbleberry, totara, toyon, wampee, water apple, wax apple, wax jambu, acerola, white aspen, white mulberry, white sapote, wild grape, wild orange, wild peach, wild plum, wild mangosteen, wineberry, wolfberry, wongi, wood apple, yangmei, yellow plum, yew, youngberry, and zig zag vine.

35. The beverage system of claim 32 wherein said vegetable flavor, vegetable skin flavor, vegetable oil flavor, and vegetable fat flavor are selected from group consisting of root vegetable, fruit vegetable, flower bud, flower, stem shoot, stem, leaf, bulb, cereal grain, nut, seed, bean, and sea vegetable, including aloe vera, jojoba, ahipa, arracacha, bamboo shoot, beetroot, burdock, broadleaf arrowhead, camas, canna, carrot, cassava, celeriac, chinese artichoke, daikon, earthnut pea, elephant foot yam, ensete, galangal, ginger, ginseng, hamberg parsley, horseradish, lotus root, jerusalem artichoke, jicama, mashua, parsley root, parsnip, pignut, potato, prairie turnip, radish, rutabaga, salsify, scorzonera, skirret, swede, sweet potato, taro, ti, tigernut, turmeric, turnip, ulluco, wasabi, water caltrop, water chestnut, yalcon, yam, avocado, bell pepper, bitter melon, bitter gourd, breadfruit, chayote, cucumber, ivy gourd, eggplant, aubergine, brinjal, luffa, nopal, okra, pepper, pumpkin, squash, sweet corn, sweet pepper, tinda, tomatillo, tomato, west indian gherkin, winter melon, zucchini, courgette, artichoke, broccoli, caper, cauliflower, courgette flower, globe artichoke, squash blossom, asparagus, prussian asparagus, bamboo shoot, celery, leek, wild leek, lemongrass, rhubarb, cardoon, kurrat, galangal, amaranth, arugula, beet green, bok choy, borage, broccoli rabe, brussel sprout, cabbage, catsear, celery, celtuce, chard, chaya, chickweed, chicory, chinese mallow, chive, choi sum, chrysanthemum, collard green, common purslane, corn salad, cress, dandelion, endive, fat hen, fiddlehead, fluted pumpkin, garden rocket, golden samphire, good king henry, greater plantain, kai lan, kale, komatsuna, kuka, lagos bologi, lamb's lettuce, lamb's quarters, land cress, leek, lettuce, lizard's tail, malabar spinach, melokhia, miner's lettuce, mizuna green, mustard green, napa cabbage, new zealand spinach, orache, pak choy, paracress, pea, poke, radicchio, samphire, sculpit, stridolo, sea beet, sea kale, sierra leoni bologi, soko, sorrel, spinach, summer purslane, swiss chard, tatsoi, turnip green, watercress, water spinach, wheatgrass, winter purslane, yarrow, yao choy, cardoon, chive, florence fennel, elephant garlic, garlic, garlic chive, kohlrabi, onion, pearl onion, potato onion, spring onion, tree onion, welsh onion, quamash, scallion, shallot, rice, barley, oat, barley, rye, corn, wheat, buckwheat, millet, sorghum, spelt, quinoa, chicory, molasses, beet root, fonio, palmer's grass, teff, triticale, cattail, chia, flax, grain amaranth, canihua, pitseed goosefoot, wattleseed, almond, cashew, chestnut, coconut, hazelnut, macadamia, peanut, pecan, pine nut, pistachio, walnut, acorn, brazil nut, gingko nut, shea nut, beechnut, candlenut, kurrajong, mongongo, palm nut, karuka, red bopple nut, hickory, jacknut, pepea nut, yellow walnut, cycad, munya nut, monkey puzzle nut, paradise nut, colocynth, filbert, mamoncillo, maya nut, ogbono nut, water caltrop, juniper, podocarp, cempedak, coffee, egusi, fox nut, jackfruit, malabar gourd, nutmeg, breadnut, betel nut, cola nut, pili nut, olive, drumstick, okra, pumpkin seed, sesame seed, sunflower seed, lotus seed, hemp seed, green bean, red bean, azuki bean, black bean, back eyed bean, white bean, yellow bean, common bean, broad bean, pinto bean, soybean, lima bean, kidney bean, pea bean, potato bean, dolichos bean, moth bean, mung bean, ricebean, runner bean, tepary bean, urad bean, velvet bean, winged bean, yardlong bean, chickpea, pigeon pea, snap pea, snow pea, lentil, lupin, tarwi, carob, guar, horse gram, cocoa bean, bambara groundnut, cowpea, hyacinth bean, lablab, moringa oleifera, sterculia, yam bean, alfalfa, clover, mesquite, carob, tamarind, wisteria, aonori, arame, carola, caulerpa, dabberlocks, dulse, hijiki, kombu, laver, mozuku, nori, ogonori, sea grape, sea lettuce, sea weed, wakame, truffle, mushroom, and bean sprout.

36. The beverage system of claim 32 wherein said plant flavor, plant oil flavor,herb flavor, tea flavor, root flavor, flower flavor, flower bud flavor, pollen flavor, leaf flavor, stem flavor, stem shoot flavor, bulb flavor, nut flavor, seed flavor, bean flavor, and cereal grain flavor are selected from group consisting of leaf, flower, flower bud, pollen, bulb, root, stem, stem shoot, and herb, including hop, menthol, cordyceps, echinacea, elder, horehound, mallow, sage, thyme, cowslip, burnet, yarrow, marsh mallow, lady's mantle, speedwell, plantain, linden flowers, wild thyme, hyssop, eucalyptus, sea buckthorn, elder blossom, verbena, lemon balm, clove, coriander, cumin, basil, dill, rosemary, parsley, fennel, oregano, allspice, catnip, wormwood, musk, chili, horseradish, turmeric, mustard, curry, wasabi, mountain mint, peppermint, spearmint, wintergreen, cinnamon, licorice, rose, jasmine, chamomile, chrysanthemum, lavender, acacia, safflower, vanilla, asafoetida, balsam, bay, buchu, birch, camphor, cannabis, caraway, calamus, cistus, citronella, clary sage,costus, cubeb, cypress, cypriol,davana, elecampane, fenugreek, fir, frankincense, galbanum, geranium, goldenrod, henna, helichrysum, hickory, juniper, ledum, litseacubeba, marjoram, melaleuca, mountain savory, mugwort, myrrh, myrtle,neroli, nutmeg, orris,palosanto, petitgrain, pine, ravensara, red cedar, rosewood, sage, sassafras,schisandra, spikenard, spruce, tea tree, tsuga, valerian, yarrow, ylangylang, zedoary, benzoin, copaiba, manuka, bergamot, patchouli, lilium, ambergris, gardenia, oakmoss, labdanum, coumarin, iris, water lily, ivy, amber, carnation, vetiver, cardamom, freesia, cyclamen, muguet, gardenia, tuberose, tonka bean,agarwood, cedarwood, sandalwood, alfafa, apple, orange, lemon, lime, grapefruit, grape, guava, plum, peach, pear, blackberry, blueberry, strawberry, cranberry, raspberry, cherry, mango, pineapple, pomegranate, papaya, watermelon, rockmelon, hamimelon, melon, honeydew, coconut, durian, passion fruit, banana, fig, apricot, mandarin, blackcurrant, starfruit, kiwi, pomelo, lychee, loquat, persimmon, tangerine, mangosteen, noni, sugar apple, mulberry, elderberry, gooseberry, lingonberry, juniper berry, jackfruit, dragonfruit, abiu, acai, acerola, ackee, cherry orange, moringa, ambarella, araza, arhat, atemoya, atherton raspberry, babaco, bacupari, bacuri, bael, barbadine, beach plum, batuan, bearberry, bignay, bilberry, bilimbi, biriba, black apple, black cherry, black raspberry, black mulberry, black sapote, blood orange, bolwarra, boquila, blue tongue, breadfruit, broad leaf bramble, buddha's hand, buffaloberry, brush cherry, burdekin plum, bush tomato, button mangosteen, caimito, calabash tree, calamondin, calamansi, camucamu, canary melon, canistel, cape gooseberry, capuli cherry, carambola, cardon, carob, cashew apple, cassabanana, cattley guava, cawesh, cedar bay cherry, ceriman, cereus peruvianus, charichuelo, chayote, che, chempedak, chenet, cherimoya, cherry ballart, chokeberry, chokecherry, chupa chupa, citron, clementine, cloudberry, cluster fig, cocky apple, coco plum, cocona, cocoplum, coffee cherry, common apple berry, conkerberry, cornelian cherry, crowberry, cupuacu, currant, curry leaf apple, custard apple, elephant apple, key apple, damson plum, date, date plum, davidson's plum, dead man's finger, desert banana, desert fig, desert lime, dodder laurel, doubah, double coconut, duku, eastern may hawthorn, emu apple, emu berry, false mastic, feijoa, fibrous satinash, finger lime, florida strangler fig, gac, galia melon, gambooge, genip, giant granadilla, otaheite gooseberry, goumi, governor's plum, montessa granadilla, yellow granadilla, greengage, grumichama, guanabana, guarana, cattley guava, pineapple guava, purple guava, strawberry guava, guavaberry, hackberry, hairless rambutan, hardy kiwi, hawthorn, hog plum, honeysuckle, horned melon, huckleberry, huito, ice cream bean, llama, lllawarra plum, imbe, jabuticaba, jambul, jatoba, jelly palm, jocote, jujube, kabosu, kaffir lime, kahikatea, kakadu lime, kakadu plum, kapok, karkalla, karonda, kei apple, kepel fruit, keule, key lime, kitembilla, korlan, kumquat, kutjera, kwai muk, lady apple, lakoocha, langsat, lanzone, lapsi, lardizabala, lemon aspen, leucaena, lillypilly, little gooseberry tree, limequat, loganberry, longan, lucuma, ma praang, mabolo, madrono, malabar plum, mamey sapote, mamoncillo, mangaba, manoao, maqui, marang, manila, mayapple, malay apple, mammee apple, maypop, medlar, melinjo, melon pear, midyim, miracle fruit, mock strawberry, purple mombin, red mombin, yellow mombin, monstera, mora de castilla, morinda, morinda citrifolia, mortiflo, mountain pepper, mountain soursop, wild plum, mundu, muntries, muscadine, muskmelon, naartjie, nageia, nance, nannyberry, naranjilla, neem, nere, nonda plum, nungu, oil palm, oregan grape, oroblanco, otaheite gooseberry, palmyra palm, pawpaw, peachpalm, peanut butter fruit, pepino, pequi, peumo, phalsa, pigeon pea, pigeon plum, pigface, pindo palm, pineapple guava, pitomba, pois doux, pommecythere, pommerac, prickly pear, prune, pulasan, pummelo, pupunha, purple apple berry, purple granadilla, quandong, queensland ebony, quince, raisin tree, rambutan, red granadilla, red mulberry, rhubarb, riberry, rimu, rollinia, rose apple, rose hip, rose leaf bramble, rose myrtle, rowan, safou, sageretia, saguaro, salak, salal, salmonberry, sandpaper fig, santol, mamey, sapodilla, fibrous satinash, saskatoonberry, saw palmetto, sea buckthorn, serviceberry, shipova, small leaf tamarind, snow berry, soncoya, servicetree, soursop, southern crabapple, spanish lime, spanish tamarind, spiny monkey orange, star apple, carambola, strawberry guava, ugni, strawberry pear, surinam cherry, sweet apple berry, sweet ganadilla, sweet lemon, sweet orange, sweet pepper, sweetsop, sycamore fig, tamarillo, tamarind, monkey tamarind, velvet tamarind, tanjong, texas persimmon, thimbleberry, totara, toyon, wampee, water apple, wax apple, wax jambu, acerola, white aspen, white mulberry, white sapote, wild grape, wild orange, wild peach, wild plum, wild mangosteen, wineberry, wolfberry, wongi, wood apple, yangmei, yellow plum, yew, youngberry, zig zag vine, ahipa, arracacha, bamboo shoot, beetroot, burdock, broadleaf arrowhead, camas, canna, carrot, cassava, celeriac, chinese artichoke, daikon, earthnut pea, elephant foot yam, ensete, galangal, ginger, ginseng, hamberg parsley, lotus root, jerusalem artichoke, jicama, mashua, parsley root, parsnip, pignut, potato, prairie turnip, radish, rutabaga, salsify, scorzonera, skirret, swede, sweet potato, taro, ti, tigernut, turnip, ulluco, wasabi, water caltrop, water chestnut, yalcon, yam, avocado, bell pepper, bitter melon, bitter gourd, breadfruit, chayote, cucumber, ivy gourd, eggplant, aubergine, brinjal, luffa, nopal, okra, pepper, pumpkin, squash, sweet corn, sweet pepper, tinda, tomatillo, tomato, west indian gherkin, winter melon, zucchini, courgette, artichoke, broccoli, caper, cauliflower, courgette flower, globe artichoke, squash blossom, asparagus, prussian asparagus, bamboo shoot, celery, leek, wild leek, lemongrass, rhubarb, cardoon, kurrat, galangal, amaranth, arugula, beet green, bok choy, borage, broccoli rabe, brussel sprout, cabbage, catsear, celery, celtuce, chard, chaya, chickweed, chicory, chinese mallow, chive, choi sum, collard green, common purslane, corn salad, cress, dandelion, endive, fat hen, fiddlehead, fluted pumpkin, garden rocket, golden samphire, good king henry, greater plantain, kai lan, kale, komatsuna, kuka, lagos bologi, lamb's lettuce, lamb's quarters, land cress, leek, lettuce, lizard's tail, malabar spinach, melokhia, miner's lettuce, mizuna green, mustard green, napa cabbage, new zealand spinach, orache, pak choy, paracress, pea, poke, radicchio, samphire, sculpit, stridolo, sea beet, sea kale, sierra leoni bologi, soko, sorrel, spinach, summer purslane, swiss chard, tatsoi, turnip green, watercress, water spinach, wheatgrass, winter purslane, yarrow, yao choy, cardoon, chive, florence fennel, elephant garlic, garlic, garlic chive, kohlrabi, onion, pearl onion, potato onion, spring onion, tree onion, welsh onion, quamash, scallion, shallot, rice, barley, oat, barley, rye, corn, wheat, buckwheat, millet, sorghum, spelt, quinoa, chicory, molasses, beet root, fonio, palmer's grass, teff, triticale, cattail, chia, flax, grain amaranth, canihua, pitseed goosefoot, wattleseed, almond, cashew, chestnut, coconut, hazelnut, macadamia, peanut, pecan, pine nut, pistachio, walnut, acorn, brazil nut, gingko nut, shea nut, beechnut, candlenut, kurrajong, mongongo, palm nut, karuka, red bopple nut, hickory, jacknut, pepea nut, yellow walnut, cycad, munya nut, monkey puzzle nut, paradise nut, colocynth, filbert, mamoncillo, maya nut, ogbono nut, water caltrop, juniper, podocarp, cempedak, coffee, egusi, fox nut, jackfruit, malabar gourd, nutmeg, breadnut, betel nut, cola nut, pili nut, olive, drumstick, okra, pumpkin seed, sesame seed, sunflower seed, lotus seed, hemp seed, green bean, red bean, azuki bean, black bean, back eyed bean, white bean, yellow bean, common bean, broad bean, pinto bean, soybean, lima bean, kidney bean, pea bean, potato bean, dolichos bean, moth bean, mung bean, ricebean, runner bean, tepary bean, urad bean, velvet bean, winged bean, yardlong bean, chickpea, pigeon pea, snap pea, snow pea, lentil, lupin, tarwi, carob, guar, horse gram, cocoa bean, coffee bean, bambara groundnut, cowpea, hyacinth bean, lablab, moringa oleifera, sterculia, yam bean, alfalfa, clover, mesquite, carob, tamarind, wisteria, aonori, arame, carola, caulerpa, dabberlocks, dulse, hijiki, kombu, laver, mozuku, nori, ogonori, sea grape, sea lettuce, sea weed, wakame, truffle, mushroom, bean sprout, acai, aloe vera, arnica, ashoka, asthma weed, astragalus, barberry, belladonna, bitter leaf, bitter orange, black cohosh, blessed thistle, cat's claw, cayenne, chaparral, chasteberry, cinchona, coffee senna, comfrey, digitalis, dong quai, ephedra, european mistletoe, evening primrose, fenugreek, feverfew, flaxseed, gingko, goldenseal, hoodia, horse chestnut, horsetail, jamaica dogwood, jojoba, kava, khat, konjac, kratom, kanna, licorice root, marigold, moringa oleifera, milk thistle, neem, opium poppy, purple coneflower, passion flower, red clover, syrian rue, st john's wort, saw palmetto, tea tree oil, thunder god vine, tulasi, turmeric, umckaloabo, valerian, white willow, yerba santa, ajwain, akudjura, alexanders, alkanet, alligator pepper, angelica, anise, anise hyssop, aniseed myrtle, annatto, apple mint, artemisia, asafoetida, asarabacca, avens, avocado leaf, barberry, bay leaf, bee balm, boldo, borage, black cardamom, blue fenugreek, caraway, cardamom, cassia, cayenne pepper, celery leaf, celery seed, chervil, chicory, cicely, cilantro, clary, costmary, cubeb pepper, cudweed, culantro, curry leaf, curry plant, dill seed, epazote, fenugreek, filé powder, fingerroot, galangal, galingale, ganoderma, golpar, grains of paradise, grains of selim, houttuynia cordata, huacatay, indonesian bay leaf, jimbu, kaffir lime leaves, kala zeera, kawakawa seeds, kencur, keluak, kinh gioi, kokam seed, korarima, koseret leaves, lemon myrtle, lemon ironbark, lemon verbena, leptotes bicolor, lesser calamint, lime flower, lovage, mahlab, marjoram, mastic, mountain horopito, musk mallow, nasturtium, nigella, njangsa, neem, olida, orris root, pandan flower, pandan leaf, paprika, paracress, peppermint gum leaf, perilla, pandanus amaryllifolius, quassia, ramsons, rice paddy herb, rue, saffron, salad burnet, salep, sassafras, savory, silphium, shiso, sorrel, spikenard, star anise, sumac, sweet woodruff, tarragon, voatsiperifery, water-pepper, wattleseed, wild betel, willow herb, wood avens, and woodruff.

37. The beverage system of claim 32 wherein said vegetable oil flavor is selected from group consisting of corn oil, canola oil, peanut oil, olive oil, coconut oil, soybean oil, sesame oil, sunflower oil, flaxseed oil, grape seed oil, pumpkin seed oil, safflower oil, argan oil, rice bran oil, palm oil, palm kernel oil, almond oil, avocado oil, cottonseed oil, hemp oil, mustard oil, macadamia oil, groundnut oil, teaseed oil, walnut oil, cashew oil, castor oil, colza oil, hazelnut oil, linseed oil, manila oil, mongongo nut oil, mustard oil, pecan oil, perilla oil, pine nut oil, pistachio oil, poppyseed oil, rapeseed oil, jojoba oil, and watermelon seed oil.

38. The beverage system of claim 32 wherein said meat flavor is selected from group consisting of chicken, duck, goose, turkey, quail, rabbit, sheep, goat, cow, pig, deer, bison, buffalo, crocodile, frog, turtle, snail, worm, bacon, sausage, animal tissue, animal organ, animal tongue, animal tail, animal feet, animal liver, animal stomach, animal intestine, animal brain, animal heart, animal skin, animal tendon, animal fat, animal bone marrow, and animal blood.

39. The beverage system of claim 32 wherein said seafood flavor is selected from group consisting of squid, cuttle fish, shrimp, crab, crayfish, octopus, clam, oyster, scallop, lobster, abalone, conch, jellyfish, prawn, hill, mussel, sea cucumber, sea urchin, eel, snail, shrimp roe, crab roe, lobster roe, fish roe, and fish.

40. The beverage system of claim 1 wherein said at least one nutritional ingredient comprises essential nutrient selected from group consisting of vitamin, dietary mineral, amino acid, and fatty acid; said vitamin includes vitamin A, vitamin B1, vitamin B2, vitamin B3, vitamin B5, vitamin B6, vitamin B7, vitamin B9, vitamin B12, vitamin C, vitamin D, vitamin E, and vitamin K; said dietary mineral includes calcium, phosphorus, potassium, sulfur, sodium, chlorine, magnesium, iron, cobalt, copper, zinc, molybdenum, iodine, selenium, manganese, nickle, chromium, fluorine, boron, and strontium; said amino acid includes histidine, isoleucine, leucine, lysine, methionine, cysteine, phenylalanine, tyrosine, threonine, tryptophan, and valine; said fatty acid includes alpha-linoleic acid, and linoleic acid; and said at least one nutritional ingredient is in form selected from group consisting of extract, juice, sauce, liquid, oil, gel, jelly, wax, cream, paste, powder, thin layer, small particles, and small pieces.

41. The beverage system of claim 1 wherein said at least one health ingredient comprises medication and other health ingredient; said medication is mixed into said beverage for ease of consumption; said other health ingredient is selected from group consisting of electrolyte, lactase, yeast, propolis, and quinine; and said at least one health ingredient is in form selected from group consisting of extract, juice, sauce, liquid, oil, gel, jelly, wax, cream, paste, powder, thin layer, small particles, and small pieces.

42. The beverage system of claim 1 wherein said at least one other ingredient comprises food additive selected from group consisting of acid, acidity regulator, alcohol, anticaking agent, antifoaming agent, antioxidant, bulking agent, coagulation agent, food coloring, color retention agent, emulsifier, flavor enhancer, flour treatment agent, gelling agent, glazing agent, humectant, leavening agent, tracer gas, preservative, stabilizer, sweetener, tenderizer, and thickener.

43. The beverage system of claim 1 having packaging as individual package and multiple package; said packaging is in air tight container; and said packaging is selected from group consisting of paper, plastic, metal, and glass.
